(19) United States
(12) Patent Application Publication
(10) Pub. No.: US 2026/0079345 A1
(43) Pub. Date: Mar. 19, 2026

(54) LIGHT-GUIDE OPTICAL ELEMENTS WITH EMBEDDED BEAM SPLITTER OVERLAPPING COUPLING-OUT REGION

(71) Applicant: LUMUS LTD., Ness Ziona (IL)

(72) Inventors: Eitan RONEN, Rechovot (IL); Ronen CHRIKI, Lod (IL)

(21) Appl. No.: 19/134,731

(22) PCT Filed: Jun. 3, 2024
(86) PCT No.: PCT/IL2024/050547

§ 371 Date: Jun. 1, 2025

Related U.S. Application Data
(60) Provisional application No. 63/470,967, filed on Jun. 4, 2023.

(51) Int. Cl. G02B 27/01

(52) U.S. Cl. CPC G02B 27/0172

(57) ABSTRACT

An optical system has a light-guide optical element (LOE) with a pair of parallel major external surfaces that support propagation of image illumination within the LOE by internal reflection at the major external surfaces. A plurality of mutually-parallel partially reflecting surfaces is deployed within a coupling-out region of the LOE obliquely to the major external surfaces, and couples out at least part of the image illumination from the LOE towards an eye-motion box. In an embodiment, a planar homogenizer is internal to the LOE and parallel to the major external surfaces, and at least partially extends into the coupling-out region so as to overlap with some but not all of the mutually-parallel partially reflecting surfaces. In another embodiment, the LOE includes a second plurality of mutually-parallel partially reflecting surfaces, and the homogenizer is alternatively deployed in overlapping relation with the second plurality of mutually-parallel partially reflecting surfaces.

### CROSS-REFERENCE TO RELATED APPLICATIONS

This application claims priority from U.S. Provisional Ser. No. 63/470,967, filed Jun. 4, 2023, whose disclosure is incorporated by reference in its entirety herein.

### TECHNICAL FIELD

The present disclosure relates to optical systems, and, in particular, it concerns an optical system including a light-guide optical element (LOE) for achieving optical aperture expansion.

### BACKGROUND OF THE INVENTION

Optical arrangements for near eye display (NED), head mounted display (HMD) and head up display (HUD) require large aperture to cover the area where the observer's (i.e., user's, viewer's) eye is located (commonly referred to as the eye-motion box—or EMB). In order to implement a compact device, the image that is to be projected into the observer's eye is generated by a small optical image generator (projector) having a small optical aperture. The image from the image projector is conveyed to the eye by an LOE, which expands (multiplies) the image to generate a large aperture.

In order to achieve uniformity of the viewed image, the LOE should be uniformly “filled” with the projected image and its conjugate image. This imposes design limitations on the size of the image projector and various other aspects of the optical design.

### SUMMARY OF THE INVENTION

The present disclosure provides an optical system having a light-guide optical element (LOE) for directing image illumination from an image projector to an eye-motion box for viewing by an eye of a user.

According to the teachings of an embodiment of the present disclosure, there is provided optical system for directing image illumination corresponding to a collimated image to an eye-motion box for viewing by an eye of a viewer. The optical system comprises a light-guide optical element (LOE) formed from transparent material. The LOE comprises: a pair of major external surfaces that are parallel so as to support propagation of the image illumination within the LOE by internal reflection at the major external surfaces; a coupling-out configuration associated with a coupling-out region of the LOE and configured for coupling out at least part of the image illumination from the LOE towards the eye-motion box, the coupling-out configuration including a plurality of mutually-parallel partially reflecting surfaces deployed within the LOE and obliquely inclined relative to the major external surfaces; and at least one planar beam splitter internal to the LOE and parallel to the major external surfaces, the at least one planar beam splitter at least partially extending into the coupling-out region so as to overlap with some but not all of the mutually-parallel partially reflecting surfaces.

Optionally, the plurality of mutually-parallel partially reflecting surfaces have a selected deployment angle relative to the major external surfaces, the selected deployment angle being selected from a range between 55 and 70 degrees.

Optionally, the at least one planar beam splitter consists of a single beam splitter that subdivides the plurality of mutually-parallel partially reflecting surfaces into a first set of partially reflecting surfaces and a second set of partially reflecting surfaces, and the first set of partially reflecting surfaces is laterally offset from the second set of partially reflecting surfaces.

Optionally, the optical system further comprises: an image projecting arrangement for generating the image illumination corresponding to the collimated image, the image projecting arrangement being optically coupled to the LOE so as to introduce the image illumination into a coupling-in region of the LOE so as to propagate within the LOE by internal reflection.

Optionally, the LOE includes a first LOE region and a second LOE region and the major external surfaces extend across the first and second LOE regions, the coupling-out region is located in the first region of the LOE, and the second LOE region includes a coupling region having a coupling configuration associated therewith, the coupling configuration including a second plurality of mutually-parallel partially reflecting surfaces non-parallel to the plurality of mutually-parallel partially reflecting surfaces of the coupling-out configuration, the second plurality of mutually-parallel partially reflecting surfaces configured for deflecting at least part of the image illumination, propagating within the second LOE region by internal reflection at the major external surfaces, from the second LOE region into the first LOE region so as to propagate within the first LOE region by internal reflection from the major external surfaces.

Optionally, the optical system further comprises: an image projecting arrangement for generating the image illumination corresponding to the collimated image, the image projecting arrangement being optically coupled to the LOE so as to introduce the image illumination into a coupling-in region of the LOE so as to propagate from the coupling-in region toward the second LOE region by internal reflection.

Optionally, the LOE further comprises a first optical retarder and a second optical retarder, each of the first and second optical retarders being internal to the LOE and parallel to the major external surfaces, the planar beamsplitter is sandwiched between the first and second optical retarders.

Optionally, the at least one planar beam splitter includes two or more planar beam splitters that subdivide a thickness of the LOE between the major external surfaces into three or more layers of equal thickness.

Optionally, the at least one planar beam splitter consists of a single beam splitter that subdivides a thickness of the LOE between the major external surfaces into two layers of equal thickness, and the image illumination that enters one of the two layers corresponds to both the collimated image and a conjugate of the collimated image.

There is also provided according to the teachings of an embodiment of the present disclosure an optical system for directing image illumination corresponding to a collimated image to an eye-motion box for viewing by an eye of a viewer. The optical system comprises a light-guide optical element (LOE) formed from transparent material. The LOE comprises: a first LOE region containing a first plurality of planar, mutually-parallel, partially reflecting surfaces having a first orientation; a second LOE region containing a second plurality of planar, mutually-parallel, partially reflecting surfaces having a second orientation non-parallel to the first orientation; and a pair of mutually-parallel major external surfaces extending across the first and second LOE regions such that both the first plurality of partially reflecting surfaces and the second plurality of partially reflecting surfaces are located between the major external surfaces, the second plurality of partially reflecting surfaces are obliquely inclined relative to the major external surfaces so that a part of image illumination propagating within the LOE by internal reflection at the major external surfaces from the first LOE region into the second LOE region is coupled out of the LOE towards the eye-motion box, the first plurality of partially reflecting surfaces are oriented so that a part of image illumination propagating within the LOE by internal reflection at the major external surfaces from a coupling-in region of the LOE is deflected towards the second LOE region, and the LOE further comprises at least one planar beam splitter internal to the LOE and parallel to the major external surfaces, the at least one planar beam splitter located at least partially in the first LOE region so as to overlap with at least some of the partially reflecting surfaces of the first plurality of partially reflecting surfaces.

Optionally, the at least one planar beam splitter extends partially across the first LOE region such that the at least one planar beam splitter overlaps with some but not all of the partially reflecting surfaces of the first plurality of partially reflecting surfaces.

Optionally, the at least one planar beam splitter extends across substantially the entirety of the first LOE region such that the at least one planar beam splitter overlaps with all of the partially reflecting surfaces of the first plurality of partially reflecting surfaces.

Optionally, the at least one planar beam splitter subdivides the at least some of the partially reflecting surfaces of the first plurality of partially reflecting surfaces into a first set of partially reflecting surfaces and a second set of partially reflecting surfaces, and the first set of partially reflecting surfaces is laterally offset from the second set of partially reflecting surfaces.

Optionally, the LOE further comprises a first optical retarder and a second optical retarder, each of the first and second optical retarders being internal to the first LOE region and parallel to the major external surfaces, the at least one planar beam splitter is sandwiched between the first and second optical retarders.

Optionally, the at least one planar beam splitter includes two or more planar beam splitters that subdivide a thickness of the LOE between the major external surfaces into three or more layers of equal thickness.

Optionally, the at least one planar beam splitter consists of a single beam splitter that subdivides a thickness of the LOE between the major external surfaces into two layers of equal thickness, and the image illumination that enters one of the two layers corresponds to both the collimated image and a conjugate of the collimated image.

Optionally, the optical system further comprises: an image projecting arrangement for generating the image illumination corresponding to the collimated image, the image projecting arrangement being optically coupled to the LOE so as to introduce the image illumination into the coupling-in region of the LOE so as to propagate from the coupling-in region toward the first LOE region by internal reflection.

Within the context of this document, the term “guided” generally refers to light that is trapped within a light-transmitting material (e.g., a substrate) by internal reflection at major external surfaces of the light-transmitting material, such that the light that is trapped within the light-transmitting material propagates in a propagation direction through the light-transmitting material. Light propagating within the light-transmitting substrate is trapped by internal reflection when the propagating light is incident to major external surfaces of the light-transmitting material at angles of incidence that are within a particular angular range. The internal reflection of the trapped light may be in the form of total internal reflection, whereby propagating light that is incident to major external surfaces of the light-transmitting material at angles greater than a critical angle (defined in part by the refractive index of the light-transmitting material and the refractive index of the medium surrounding the light-transmitting, e.g., air) is totally internally reflected at the major external surfaces. Alternatively, the internal reflection of the trapped light may be effectuated by a coating, such as an angularly selective reflective coating, applied to the major external surfaces of the light-transmitting material to achieve reflection of light that is incident to the major external surfaces within the particular angular range.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Attention is now directed to the drawings, where like reference numerals or characters indicate corresponding or like components. In the drawings:

FIG. 1A is a schematic isometric view of an optical system implemented using a light-guide optical element (LOE) that provides one-dimensional aperture expansion, and that can be constructed according to the teachings of the present disclosure;

FIG. 1B is a schematic isometric view of an optical system implemented using a light-guide optical element (LOE) that provides two-dimensional aperture expansion, and that can be constructed according to the teachings of the present disclosure;

FIG. 2A is a schematic side view illustrating an LOE that can be used in the optical system of FIG. 1A, the LOE having a set of major external surfaces and a coupling-out configuration implemented as a set of mutually parallel partially reflecting internal surfaces obliquely inclined relative to the major external surfaces;

FIG. 2B is a schematic side view illustrating an LOE that can be used in the optical system of FIG. 1A, the LOE having a set of major external surfaces and a coupling-out configuration implemented as diffractive optical elements located at one of the major external surfaces;

FIGS. 3A-3C are schematic front, side, and plan views, respectively, illustrating an LOE that can be used in the optical system of FIG. 1B, the LOE having a set of major external surfaces, first and second regions each containing a set of mutually parallel partially reflecting internal surfaces, the partially reflecting surfaces of the first region deflecting light into the second region, and the partially reflecting surfaces of the second region deflecting light out of the LOE;

FIGS. 4A-4D schematically illustrate the propagation of ascending and descending rays through the LOE of FIG. 2A;

FIGS. 5A-5C schematically illustrate an LOE having an internal beam splitter deployed at a mid-plane of the LOE so as to subdivide the LOE into two layers of equal thickness and fully overlapping with a set of mutually parallel partially reflecting surfaces, according to an embodiment of the present disclosure, showing ascending rays initially spanning the entire cross-section of the LOE;

FIG. 6 schematically illustrates an LOE similar to FIGS. 5A-5C , but showing ascending and descending rays initially filling only one of the two layers and the other of the two layers being initially without illumination;

FIGS. 7A and 7B schematically illustrate an LOE similar to FIG. 6, but with a truncated beam splitter that only partially overlaps the set of mutually parallel partially reflecting surfaces, according to an embodiment of the present disclosure;

FIG. 8A is a schematic side view of an LOE similar to FIGS. 5A-6, but with the beam splitter subdividing the set of mutually parallel partially reflecting surfaces into two sets of partially reflecting surfaces that are laterally offset one with respect to the other, according to an embodiment of the present disclosure;

FIG. 8B is a schematic side view of an LOE similar to FIG. 8A, but with partially reflecting surfaces being on only one side of the beam splitter and more tightly spaced, according to an embodiment of the present disclosure;

FIG. 8C is a schematic side view of an LOE similar to FIG. 8A, but with the partially reflecting surfaces in each set being more tightly spaced, according to an embodiment of the present disclosure;

FIG. 9A is a schematic side view of an LOE similar to FIGS. 5A-6, but with a pair of beam splitters subdividing the LOE into three layers of equal thickness, according to an embodiment of the present disclosure;

FIG. 9B is a schematic side view of an LOE similar to FIG. 9A, but with partially reflecting surfaces located in only one of the three layers;

FIG. 9C is a schematic side view of an LOE similar to FIGS. 9A and 9B, but with partially reflecting surfaces located in two adjacent layers, and with the partially reflecting surfaces in the two layers being laterally offset one with respect to the other;

FIG. 9D is a schematic side view of an LOE similar to FIG. 9A, but with the partially reflecting surfaces in the three layers being laterally offset one with respect to the other, according to an embodiment of the present disclosure;

FIG. 10 is a schematic side view of an LOE similar to the LOE of FIGS. 7A and 7B, but with steeper angled partially reflecting surfaces, and showing a tracing of rays corresponding to an edge and center of the FOV;

FIGS. 11A and 11B are schematic front and plan views, respectively, illustrating an LOE similar to the LOE of FIGS. 3A-3C , but having an internal beam splitter deployed at a mid-plane of the LOE in the first region so as to subdivide the LOE into two layers of equal thickness and fully overlapping with the partially reflecting surfaces of the first region, according to an embodiment of the present disclosure;

FIG. 11C is a schematic plan view similar to FIG. 11B, but with a truncated beam splitter that only partially overlaps the partially reflecting surfaces of the first region, according to an embodiment of the present disclosure;

FIG. 12A is a schematic plan view similar to FIG. 11B, but showing the partially reflecting surfaces without lateral offset, according to an embodiment of the present disclosure;

FIG. 12B is an enlarged view of region of FIG. 12A designated XII, showing the beam splitter sandwiched between a pair of optical retarders, according to an embodiment of the present disclosure;

FIGS. 13A-13E illustrate steps for fabricating an LOE, such as the LOE of FIGS. 11A and 11B, according to embodiments of the present disclosure;

FIGS. 14A-15F illustrate steps for fabricating the first region of an LOE, such as the LOE of FIGS. 12A and 12B, according to embodiments of the present disclosure;

FIGS. 16A-18C illustrate steps for mass-producing LOEs, each LOE being according to FIGS. 11A and 11B, according to embodiments of the present disclosure; and

FIGS. 19A-19F illustrate steps for fabricating an LOE, such as the LOE of FIGS. 5A-8A and 10, according to embodiments of the present disclosure.

### DESCRIPTION OF THE PREFERRED EMBODIMENTS

Certain embodiments of the present disclosure provide an optical system having a light-guide optical element (LOE) for achieving optical aperture expansion for the purpose of a head-up display, and most preferably a near-eye display, which may be a virtual reality display, or more preferably an augmented reality display.

The principles and operation of the optical system and LOE according to the present disclosure may be better understood with reference to the drawings accompanying the description.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the examples. The disclosure is capable of other embodiments or of being practiced or carried out in various ways.

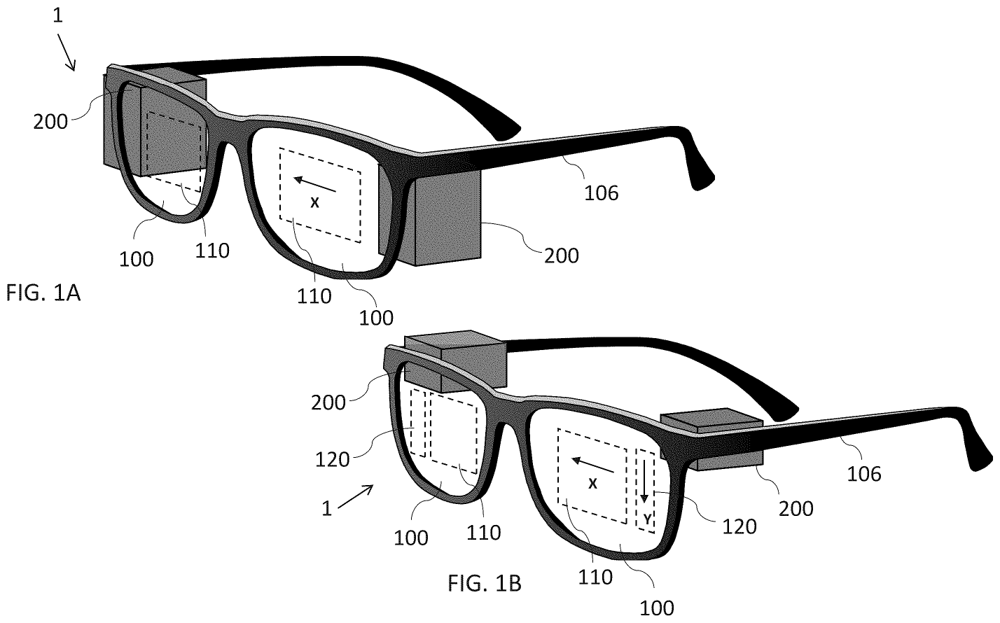

Referring now to the drawings, FIG. 1A schematically illustrates an exemplary implementation of a device in the form of a near-eye display, generally designated 1, employing an LOE 100 that can be constructed according to the teachings of an embodiment of the present disclosure. The near-eye display 1 employs a compact image projector (or “POD”) 200 optically coupled so as to inject an image into the LOE (interchangeably referred to as a “waveguide,” a “substrate” or a “slab”) 100 within which the image light is trapped by internal reflection at a set of mutually-parallel planar external surfaces. The propagating image light interacts with an optical coupling-out configuration, not illustrated in FIG. 1A but located in a region 110 of the LOE 100, that defines a coupling-out region, which progressively deflects (couples-out) a proportion of the image illumination out of the LOE 100 towards the eye of an observer located within a region defined as the eye-motion box (EMB), thereby achieving expansion of the optical aperture in one dimension. The coupling-out configuration can be implemented as a set of partially-reflecting surfaces (interchangeably referred to as “facets”) that are parallel to each other, and inclined obliquely to the direction of propagation of the image light, which in the present case is also oblique to the mutually-parallel planar external surfaces, with each successive facet deflecting a proportion of the image light. Alternatively, the optical coupling-out configuration can be implemented as a diffractive optical element located at one of the planar external surfaces of the LOE 100. Within the context of the present disclosure, LOEs that achieve only a single dimension of aperture expansion are referred to interchangeably as 1D LOEs.

FIG. 1B illustrates another exemplary implementation of device 1 in which the LOE 100, which can be constructed according to the teachings of an embodiment of the present invention, performs two-stage and two-dimensional optical aperture expansion. Here, the LOE 100 includes a further optical coupling configuration, not illustrated in FIG. 1B but located in a further region 120 of the LOE 100, that defines a coupling region. The further optical coupling configuration can be implemented as a further set of facets obliquely inclined to the direction of propagation of the image light and having an orientation non-parallel to the orientation of the facets located in the region 110, or can be implemented as a further diffractive optical element. Throughout the majority of the remainder of the description, the optical systems and LOEs of the present disclosure will be described in the context of coupling-out configurations implemented as sets of facets. However, it should be apparent that implementation of coupling configurations using diffractive elements is also applicable.

With continued reference to FIG. 1B, the propagating image illumination impinges on the facets in the region 120, with each successive facet deflecting a proportion of the image light into a deflected direction, also trapped/guided by internal reflection within the LOE 100. This partial reflection at successive facets achieves a first dimension of optical aperture expansion. In a first set of preferred but non-limiting examples of the present disclosure, the set of facets in the region 120 are orthogonal to the major external surfaces of the LOE 100. In this case, both the injected image and its conjugate undergoing internal reflection as it propagates within region 120 are deflected and become conjugate images propagating in a deflected direction. In an alternative set of preferred but non-limiting examples, the first set of partially-reflecting surfaces are obliquely angled relative to the major external surfaces of the LOE 100. In the latter case, either the injected image or its conjugate forms the desired deflected image propagating within the LOE 100, while the other reflection may be minimized, for example, by employing angularly-selective coatings on the facets which render them relatively transparent to the range of incident angles presented by the image whose reflection is not needed.

The deflected image illumination from the region 120 then passes into the other region 110 (i.e., the facets in the region 120 couple the image illumination out of the region 120 and into the other region 110). The other region 110 may be implemented as an adjacent distinct substrate or as a continuation of a single substrate. The coupling-out configuration associated with the region 110 (e.g., the facets in the region 110) progressively couples out a proportion of the image illumination towards the eye of the observer located in the EMB, thereby achieving a second dimension of optical aperture expansion. Within the context of the present disclosure, LOEs that achieve two dimensions of aperture expansion are referred to interchangeably as 2D LOEs.

Reference is made herein in the drawings to an X axis which extends horizontally (FIGS. 1A and 1B), in the general extensional direction of the region 110 of the LOE 100, and a Y axis (FIG. 1B) which extends perpendicular thereto, i.e., vertically in FIG. 1B.

In very approximate terms, the region 110 of the LOE 100, may be considered to achieve aperture expansion in the X direction while the region 120 of LOE 100, achieves aperture expansion in the Y direction. Within the context of this document, the region 110 is referred to interchangeably as the “first LOE” or “second LOE” or “first LOE region” or “second LOE region”, and the region 120 is referred to interchangeably as the “second LOE” or “first LOE” or “second LOE region” or “first LOE region”.

The POD 200 employed with the devices of the present disclosure is preferably configured to generate a collimated image, i.e., in which the light of each image pixel is a parallel beam, collimated to infinity, with an angular direction corresponding to the pixel position. The image illumination thus spans a range of angles corresponding to an angular field of view in two dimensions. The POD 200 includes at least one light source, typically deployed to illuminate a spatial light modulator, such as an LCOS chip. The spatial light modulator modulates the projected intensity of each pixel of the image, thereby generating an image. Alternatively, the image projector may include a scanning arrangement, typically implemented using a fast-scanning mirror, which scans illumination from a laser light source across an image plane of the projector while the intensity of the beam is varied synchronously with the motion on a pixel-by-pixel basis, thereby projecting a desired intensity for each pixel. In both cases, collimating optics are provided to generate an output projected image which is collimated to infinity. Some or all of the above components are typically arranged on surfaces of one or more polarizing beam-splitter (PBS) cube or other prism arrangement, as is well known in the art.

Optical coupling of the image projector 200 to the LOE 100 may be achieved by any suitable optical coupling, such as for example via a coupling prism with an obliquely angled input surface, or via a reflective coupling arrangement, via a side edge and/or one of the major external surface of the LOE. Details of the coupling-in configuration are not critical to the invention, and are shown in further figures schematically as a non-limiting example of a wedge prism applied to one of the major external surfaces of the LOE.

It will be appreciated that the near-eye display 1 includes various additional components, typically including a controller for actuating the image projector 200, typically employing electrical power from a small onboard battery (not shown) or some other suitable power source. It will be appreciated that controller includes all necessary electronic components such as at least one processor or processing circuitry to drive the image projector, all as is known in the art.

It is noted that the various optical components of the devices disclosed herein form an optical system. Thus, for example, the LOE, coupling-out configuration(s) (e.g., facets or diffractive optical elements), image projector, coupling-in prism, etc., form an optical system. It is further noted that overall device (and optical system) of FIGS. 1A and 1B may be implemented separately for each eye, and is preferably supported relative to the head of a user with the each LOE 100 facing a corresponding eye of the user. In one particularly preferred option as illustrated here, a support arrangement is implemented as an eye glasses frame with sides 106 for supporting the device relative to ears of the user. Other forms of support arrangement may also be used, including but not limited to, head bands, visors or devices suspended from helmets.

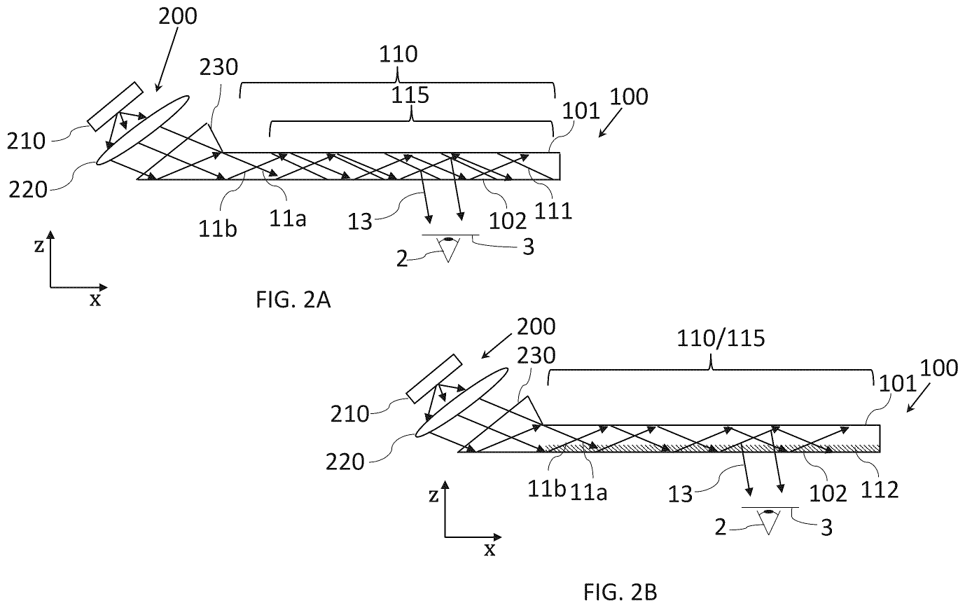

Turning now to FIGS. 2A and 2B, the optical properties of an implementation of a conventional 1D LOE that can be used in the device 1 of FIG. 1A are illustrated in more detail. Specifically, there is shown in FIG. 2A a more detailed view of a light-guide optical element (LOE) 100 formed from transparent (i.e., light-transmitting) material, having a set (pair) of mutually-parallel major external surfaces 101, 102. The main portion of the LOE 100 defines the region 110 through which image illumination propagates by internal reflection. A coupling-out region 115 is located in the region 110 (and in certain cases the two regions 110 and 115 may be one and the same) and contains a coupling-out configuration implemented as a set of planar, mutually-parallel, partially-reflecting surfaces (“facets”) 111. The facets 111 are internal to the LOE 100, i.e., they are located between the major external surfaces 101, 102, and are obliquely inclined relative to the major external surfaces 101, 102.

FIG. 2B shows an alternate example, in which the coupling-out configuration is implemented as diffractive optical elements 112 located at one of the major external surfaces 102.

In both FIGS. 2A and 2B, image illumination from a display 210 is collimated by a collimating lens 220 (the display 210 and lens 220 for example forming part of the POD 200) and coupled into the LOE 100 through an optical coupling-in arrangement (wedge prism 230) which defines a coupling-in region of the LOE 100. The coupled-in image illumination is then trapped inside the LOE 100 by internal reflection at the major external surfaces 101, 102. Parenthetically, the internal reflection of the trapped light may be in the form of total internal reflection, whereby the propagating light that is incident to the major external surfaces 101, 102 at angles greater than a critical angle (defined in part by the refractive index of the light-transmitting material of the LOE and the refractive index of the medium surrounding the LOE, e.g., air) is totally internally reflected at the major external surfaces. Alternatively, the internal reflection of the trapped light may be effectuated by a coating, such as an angularly selective reflective coating, applied to the major external surfaces of the LOE to achieve reflection of light that is incident to the major external surfaces within the particular angular range.

The image illumination propagating through the LOE 100 is represented schematically in FIGS. 2A and 2B as rays 11a and 11b. Rays 11a and 11b represent the descending and ascending rays, respectively, associated with a specific field of the image. The rays 11a and 11b propagate inside the LOE 100 until they reach the coupling-out configuration (facets 111 in FIG. 2A or diffractive elements 112 in FIG. 2B) in the coupling-out region 115, which progressively couples the propagating light out of the LOE 100 so as to be redirected as light (rays) 13 towards the EMB 3 in which the eye 2 of the observer is located, thereby achieving expansion of the optical aperture in one dimension.

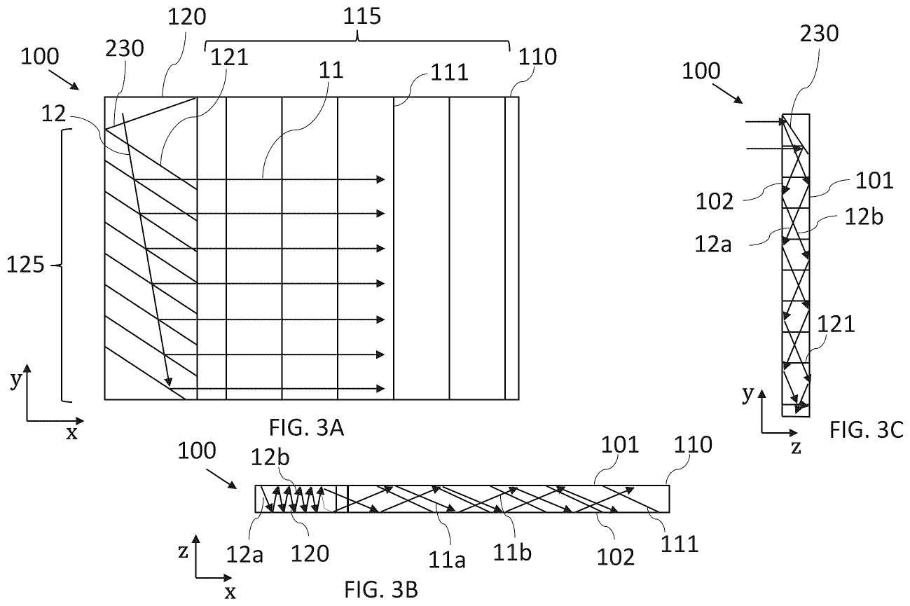

Turning now to FIGS. 3A-3C , the optical properties of an implementation of a conventional 2D LOE that can be used in the device 1 of FIG. 1B are illustrated in more detail. Here, the LOE 100 includes two LOE regions 110 and 120 each containing its own set of planar, mutually-parallel, partially reflecting surfaces (i.e., “facets”) 111 and 121. Specifically, the LOE region 110 contains a coupling-out region 115 within which a set of facets 111 is located, and the LOE region 120 contains a coupling region 125 within which a set of facets 121 is located. The regions 115 and 125 are interchangeably referred to as “faceted” regions. The major external surfaces 101, 102 extend across the two regions 110 and 120 such that both sets of facets 111 and 121 are located between the major external surfaces 101, 102. Most preferably, the major external surfaces 101, 102 are a pair of surfaces which are each continuous across the entirety of the two regions 110 and 120, although the option of having a set down or a step up in thickness between the regions 110 and 120 also falls within the scope of the present disclosure. The regions 110 and 120 may be immediately juxtaposed so that they meet at a boundary, which may be a straight boundary or some other form of boundary, or there may be one or more additional LOE region interposed between those regions, to provide various additional optical or mechanical function, depending upon the particular application. Although the present disclosure is not limited to any particular manufacturing technique, in certain particularly preferred implementations, particularly high quality major external surfaces are achieved by employing continuous external plates between which the separately formed regions 110 and 120 are sandwiched to form the compound LOE structure.

The facets 121 that are located in the coupling region 125 have an orientation that is non-parallel to the orientation of the facets 111 (i.e., the set of mutually-parallel facets 121 are oriented to be non-parallel to the set of mutually-parallel facets 111). The facets 121 are specifically oriented so that a part of image illumination propagating within the LOE 100 by internal reflection at the major external surfaces from the coupling-in region (coupling prism 230) is deflected out of the region 120 and towards (into) the region 110, thereby achieving a first dimension of optical aperture expansion. In the illustrated embodiment, the facets 121 are perpendicular to the major external surfaces 101, 102. The facets 111 that are located in the coupling-out region 115, and the orientation of the facets 111 is such that the facets 111 are at an oblique angle to the major external surfaces 101, 102 so that a part of image illumination propagating within the LOE 100 by internal reflection at the major external surfaces 101, 102 from the region 120 into the region 110 is coupled out of the LOE 100 towards the eye-motion box, thereby achieving a second dimension of optical aperture expansion.

The trajectory of the propagating image illumination for a certain field is represented schematically in FIG. 3A as rays 11 and 12. Ray 12 represents the trajectory of the illumination propagating through the region 120, and ray 11 represents the trajectory of the illumination propagating through the region 110. FIG. 3B shows the descending and ascending rays 11a and 11b of the image illumination (corresponding to the trajectory 11) in the region 110. FIG. 3C shows the descending and ascending rays 12a and 12b of the image illumination (corresponding to the trajectory 12) in the region 120.

With regards to the coupling-out region 115 and the coupling region 125 of the LOE described herein, these regions are effectively the regions of LOE 100 which are occupied by the coupling-out configurations, and span across sections of the LOE. For example, the coupling-out region 115 may effectively span the projection of the coupling-out configuration (e.g., facets 111) in the plane of one of the major external surfaces 102 along the length dimension of the LOE 100 (which is the X dimension in FIGS. 2A, 3A, and 3B), and the coupling region 125 may effectively span the projection of the other coupling-out configuration (e.g., facets 121) in a plane that is perpendicular to the major external surfaces along the height dimension (which is the Y dimension in FIGS. 3A and 3C).

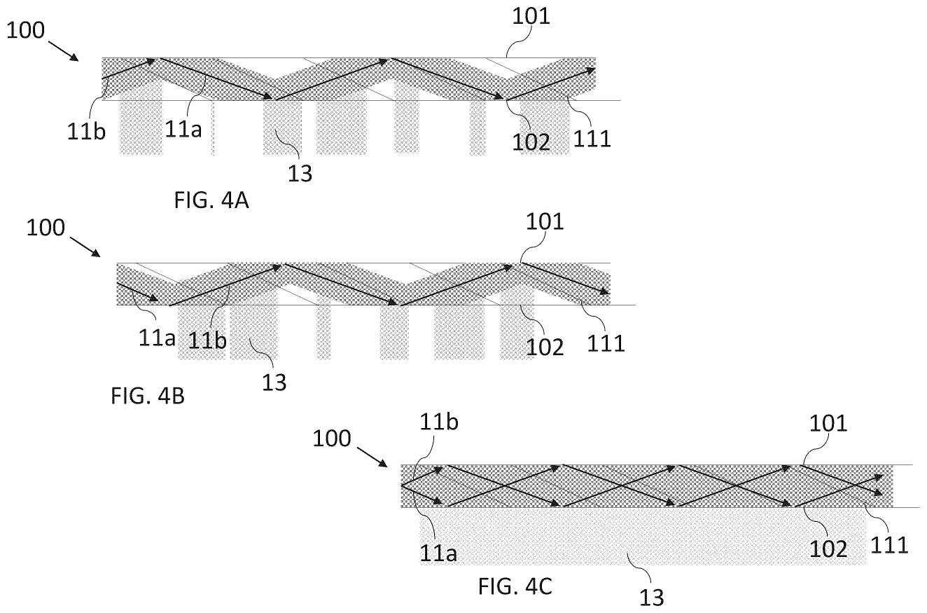

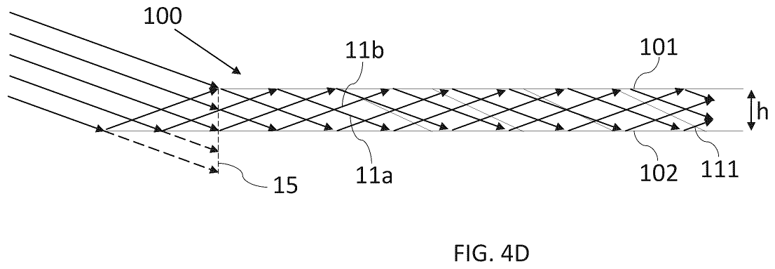

In general, the LOE 100 (whether that of FIGS. 2A and 2B, or FIGS. 3A-3C) should provide image illumination to the human eye in a uniform distribution over all propagating angles of light (also referred to as “fields” or “field of view”—FOV) and throughout the EMB. To this end, each field's aperture should be evenly filled with light. In other words, for any angle of illumination, corresponding to a pixel within the collimated image, the entire cross-section of the LOE in a plane perpendicular to the major external surfaces of the LOE should be filled with both the image and its reflection (conjugate) such that, at any point in the LOE volume, rays are present corresponding to all pixels of both the collimated image and its conjugate. FIGS. 4A-4C schematically illustrate this concept of aperture filling in the context of a 1D LOE (FIG. 2A), however similar principles apply to 2D LOEs (e.g., the LOE of FIGS. 3A-3C). In FIG. 4A, there is illustrated the projection of ascending rays 11b fully filling the entire cross-section of the LOE 100 at some initial point. As evident, the ascending rays alone result in a striped output image 13 (i.e., there are gaps), and therefore the intensity detected by the viewer's eye depends on the specific location of the eye within the EMB. Similarly, FIG. 4B shows the projection of descending rays 11a fully filling the entire cross-section of the LOE 100 at the same initial point. FIG. 4C shows that only the combination of ascending and descending rays 11b and 11a result in a uniform intensity distribution of the output illumination 13.

FIG. 4D shows that the ascending rays 11b can be “unfolded” by considering their trajectories before being reflected by the major external surface 102. As evident, the condition for aperture filling is equivalent to requiring that the rays fill an aperture 15 that is perpendicular to the major external surfaces 101, 102 of the LOE 100 and of size 2 h, where h is the thickness of the LOE.

If the “filling” condition is not met, the light projected into the eye from the LOE will not be evenly distributed. One simple conventional solution to achieve this filling condition is to employ a large image projector, for example having an aperture the size of 2 h, i.e., an aperture that meets the size of the aperture 15 in FIG. 4D, or a larger coupling-in prism. However, neither of these solutions are ideal, as they introduce bulk at the input of LOE and increase the overall size of the device. Another conventional solution is to embed a beam multiplying arrangement internal to the LOE, in a region distinct from the coupling-out region of the LOE, in order to fill-in missing image sections of the injected image illumination. However, this solution is also not ideal, as it requires additional volume in the LOE, separate from the coupling-out volume, within which to place the beam multiplier, which disadvantageously increases the overall size of the LOE.

Embodiments of the present disclosure provide solutions for aperture filling by providing a beam multiplying region within the LOE, that extends at least partially into the coupling-out region so as to overlap at least partially with the coupling-out region. The beam multiplying region contains at least one planar beam splitter (also referred to as a “planar homogenizing element” or simply “homogenizer”), embedded within the LOE and parallel to the major external surfaces, and in overlapping relation with the faceted region (coupling-out region) of the LOE. As will be discussed in further detail below, in certain embodiments the planar homogenizing element(s) is/are deployed in the faceted region 115 of a 1D LOE (such as the LOE of FIG. 2A) or a 2D LOE (such as the LOE of FIGS. 3A-3C) , whereas in other embodiments the planar homogenizing element(s) is/are deployed in the faceted region 125 of a 2D LOE (such as the LOE of FIGS. 3A-3C) . Also, as will be discussed in further detail below, the beam multiplying region is such that the planar homogenizing element(s) overlaps completely with at least the first facet of region in which the planar homogenizing element(s) is/are deployed. In certain embodiments, the beam multiplying region and the coupling-out region have the same starting point, and the beam multiplying region is fully contained within the coupling-out region or vice versa. In other embodiments, the beam multiplying region only partially extends into the coupling-out region so as to partially overlap with the coupling-out region. As will become apparent from the following description, the deployment of the beam multiplying region within, or in at least partial overlapping relation with, the coupling-out region, provides a more compact LOE design, resulting in an overall smaller form factor of the device.

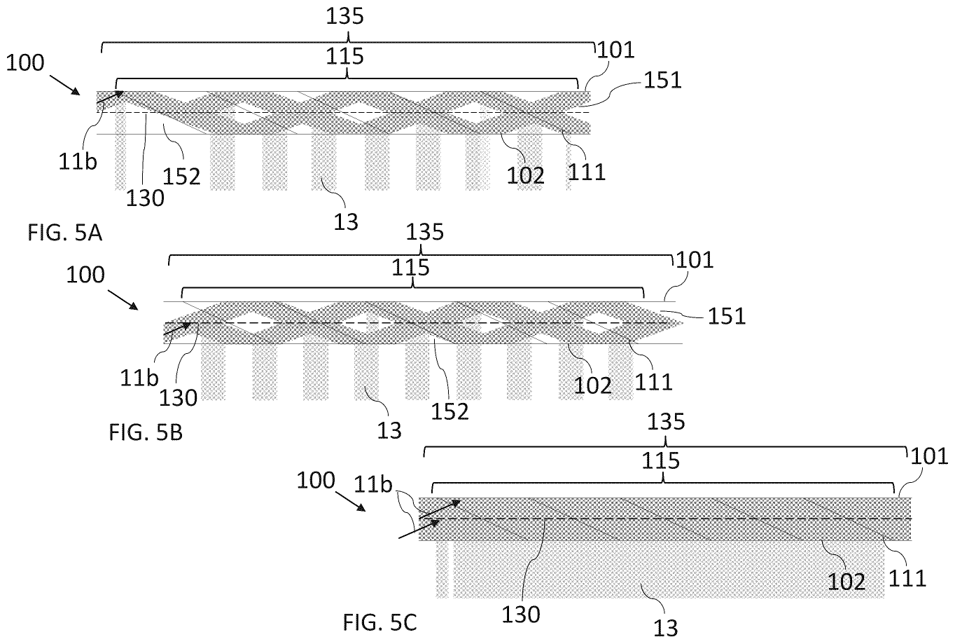

Referring now to FIGS. 5A-5C , there is illustrated a section of an LOE 100 according to one set of embodiments of the present disclosure. Here, the LOE 100 includes a beam multiplying region 135 containing a planar beam splitter 130 deployed internal to the LOE 100 and parallel to the major external surfaces 101, 102 at a mid-plane of the LOE 100 so as to subdivide the thickness (h) of the LOE 100 between the major external surfaces 101, 102 into two layers of equal thickness, designated 151 and 152. The beam multiplying region 135 contains the entirety of the coupling-out region 115, whereby the planar homogenizing element 130 extends across the entirety of the coupling-out region 115 so as to overlap with all of the facets 111 (in this case the entire projection of the facets 111 in the plane parallel to the major external surfaces 101, 102). Thus, the LOE 100 contains facets in both layers 151 and 152, on either side of the planar homogenizing element 130.

The planar homogenizing element 130 is partially reflective, preferably with a reflectivity of about 50%, however reflectivity in the range of 20%-70% may also be suitable. Structurally, the partial reflectivity of the planar homogenizing element 130 can be implemented using any suitable partially-reflective layer or coating, including but not limited to, a thin film optical coating, a metallic coating, a structural partial reflector (e.g., polka-dot patterned reflector), multi-layer dielectric coatings, and a diffractive grating.

The structure of the LOE 100 with the homogenizer 130 that induces partial reflectivity can fully fill the aperture of the LOE 100, even if the aperture that is filled is only of size h (the thickness of the LOE), rather than 2 h as in FIG. 4D. This is illustrated in FIGS. 5A-5C , which shows that the image illumination is coupled into the LOE so that initially the ascending rays 11b (or alternatively the descending rays 11a, or alternatively both ascending and descending rays) span the entire cross-section (h) of the LOE 100. FIG. 4A shows what happens to the ascending rays 11b that enter the upper half layer 151 and FIG. 4B shows what happens to the ascending rays 11b that enter into the lower half layer 152. As can be seen, when the ascending rays 11b enter into only one of the layers, the coupled-out image illumination 13 is not uniform (i.e., has gaps). FIG. 4C shows the overlap of the ascending rays 11b in the upper half layer 151 and the lower half layer 152 (spanning the entire cross-section of the LOE 100), whereby the combination of the ascending rays 11b entering the upper and lower half regions fully fills the aperture of the LOE, resulting in a uniform coupled-out image 13 (i.e., no gaps). The same result can be achieved if injecting the descending rays 11b into the upper and lower half layers. Thus, in the embodiment illustrated in FIGS. 5A-5C , the cross-section of the LOE is initially filled with illumination corresponding to the collimated image (generated by the image projector) or corresponding to a conjugate of the collimated image. In other words, in FIGS. 5A-5C, the cross-section of the LOE in the beam multiplying region 135 is filled so that there is a presence of rays corresponding to each pixel of the collimated image at every point within the cross-section of the LOE, or so that there is a presence of rays corresponding to each pixel of a reflected image corresponding to a reflection of the collimated image in a plane parallel to the major external surfaces 101, 102 at every point within the cross-section of the LOE.

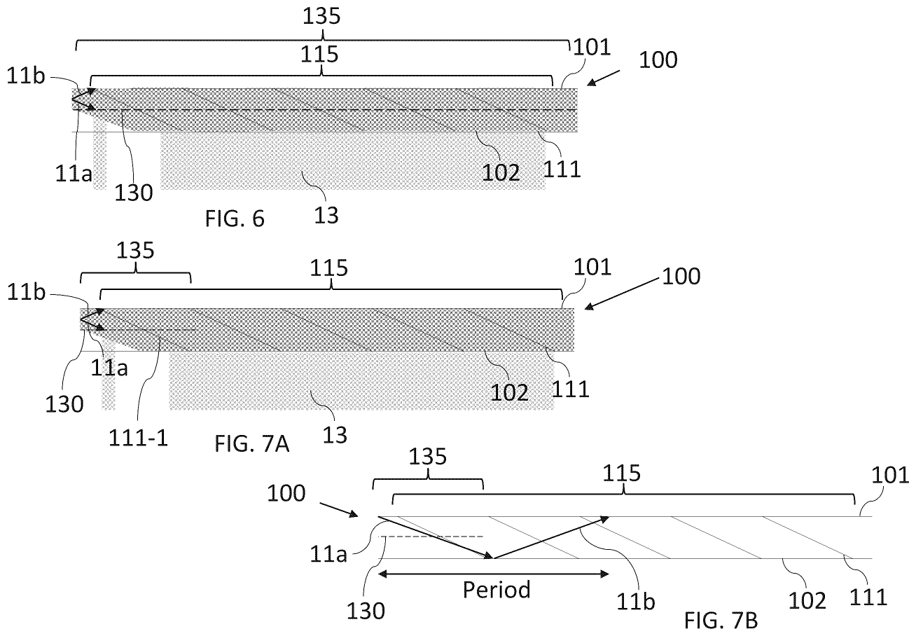

A similar result can also be achieved by filling only one of the layers 151 with both the collimated image and its conjugate while the other layer 152 is initially without illumination, i.e., injecting both the ascending and descending rays 11b and 11a into only one of the two layers 151. FIG. 6 illustrates such a configuration, where the ascending rays 11b and the descending rays 11a both initially enter the upper half layer 151 but do not initially enter the lower half layer 152, thereby filling the aperture of the LOE resulting in a uniform coupled-out image 13. Thus, in the embodiment illustrated in FIG. 6, half of the cross-section of the LOE in the beam multiplying region 135 is filled with illumination corresponding to the collimated image and illumination corresponding to a conjugate of the collimated image. In other words, in FIG. 6, half of the cross-section of the LOE in the beam multiplying region 135 is filled so that there is a presence of rays corresponding to each pixel of the collimated image at every point within the cross-section of the LOE, and so that there is a presence of rays corresponding to each pixel of a reflected image corresponding to a reflection of the collimated image in a plane parallel to the major external surfaces 101, 102 at every point within the cross-section of the LOE.

Both the configurations of FIGS. 5A-5C and FIG. 6 successfully fill the LOE 100 with image illumination so that the coupled-out illumination 13 is uniform. The particular configuration used (i.e., FIGS. 5A-5C or FIG. 6) can depend on the optical design of the image projector and/or the coupling-in arrangement (prism 230).

Although FIGS. 5A-5C and FIG. 6 illustrate an embodiment in which the homogenizer 130 extends across the entire coupling-out region 115 so as to overlap with all of the facets 111, it has been found that a homogenizer can achieve rapid filling-in of missing image sections inside the LOE so that within a relatively short distance along the length of the homogenizer 130 complete filling of the LOE is achieved. Thus, according to certain preferred but non-limiting embodiments of the present disclosure, a truncated homogenizer 130 can be used to achieve full filling of the LOE. FIG. 7A illustrates an example of such an embodiment, in which the homogenizer 130 (and hence the beam multiplying region 135) only partially extends into the coupling-out region 115 such that the homogenizer 130 overlaps with some, but not all, of the facets 111. In the illustrated embodiment, the homogenizer 130 fully overlaps with only the first facet 111-1, but does not overlap with any subsequent one of the facet 111. The length of the homogenizer 130 that is required to achieve this LOE filling is ideally no more than half of one cycle (period) of the most shallow-angled rays of the image bouncing between upper and lower major external surfaces 101, 102 of the LOE 100. This cycle (period) length is illustrated schematically in FIG. 7B.

Parenthetically, although the configuration of FIG. 7A is similar to that of FIG. 6 (i.e., both the ascending rays 11b and the descending rays 11a enter the upper half layer 151 such that the image illumination corresponding to the collimated image and a conjugate of the collimated image enters half of the cross-section of the LOE 100), an equivalent result can be achieved using a configuration similar to that of FIGS. 5A-5C (i.e., the ascending (or descending) rays enter both the upper and lower half layers such that the image illumination corresponding to the collimated image or corresponding to a conjugate of the collimated image enters the entire cross-section of the LOE 100).

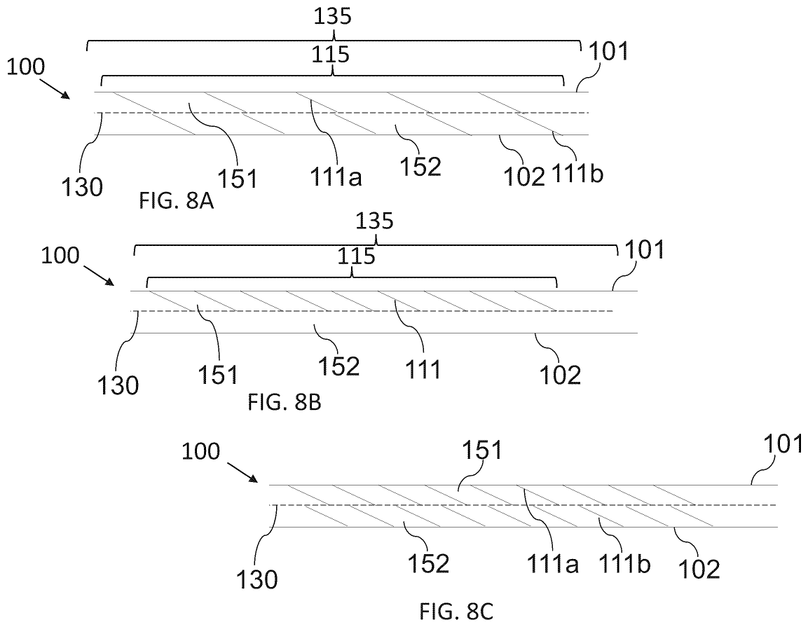

In the embodiments illustrated in FIGS. 5A-7B , there is no lateral offset between the facet portions in the upper layer 151 and lower layer 152. It is noted, however, that there may be some small alignment error between the facet portions as a practical consequence of the fabrication techniques used to implement such embodiments. If that alignment error leads to a small offset, say, for example, an offset of approximately half a wavelength, there will be a phase difference between ascending and descending rays which can cause diffraction artifacts, which is undesirable. Therefore, when implementing the embodiments of FIGS. 5A-7B , the accuracy of the alignment between the facet portions must be very high so that any resultant shift (offset) between the facet portions is very small compared to a wavelength. To avoid such strict requirements on offset tolerance, embodiments are contemplated herein in which there is a more distinguished lateral offset (i.e., an intentional offset) between the facet portions. FIG. 8A illustrates one such embodiment. Here the homogenizer 130 separates between the facets 111 so as to subdivide the facets 111 into a first set of facets 111a in the upper layer 151 and a second set of facets 111b in the lower layer 152. The two sets of facets 111a and 111b are laterally offset (displaced), one with respect to the other, by a preferably predesigned or deliberate lateral offset amount along the direction of propagation of the image illumination (the horizontal direction in the figure). The lateral offset amount is typically in the range between 10 microns and 100 microns, and more typically in the range between 10 microns and 50 microns, which is ideal when used in combination with the homogenizer to promote mixing and produce a more uniform output image (and avoiding diffraction artifacts). In the illustrated embodiment the homogenizer 130 is placed in front of the EMB, and therefore a high degree of transparency to enable viewing of the real world would dictate low reflectivity of the homogenizer 130 at lower incidence angles in addition to high reflectivity (ideally around 50%, and practically between 20% and 70%) at incident angles of the guide image illumination.

FIG. 8B shows another embodiment, in which the facets 111 are located only in one of the two layers 151. In this embodiment, in order to achieve uniformity of the coupled-out image, the facets 111 are more tightly spaced than as illustrated in the embodiment of FIG. 8A.

FIG. 8C illustrates an embodiment that can be considered as a combination of the embodiments of FIGS. 8A and 8B. Here, the homogenizer 130 subdivides the facets 111 into two sets of facets 111a and 111b (similar to as in FIG. 8A), but with tighter spacing between the facets in each set (similar to as in FIG. 8B). This allows for larger (for example maximal) lateral displacement between the two sets of facets 111a and 111b, which will generally lead to better mixing and a more uniform output image.

It should be apparent that the embodiments illustrated in FIGS. 8A-8C can be implemented with a truncated homogenizer, such as the homogenizer illustrated in FIGS. 7A and 7B.

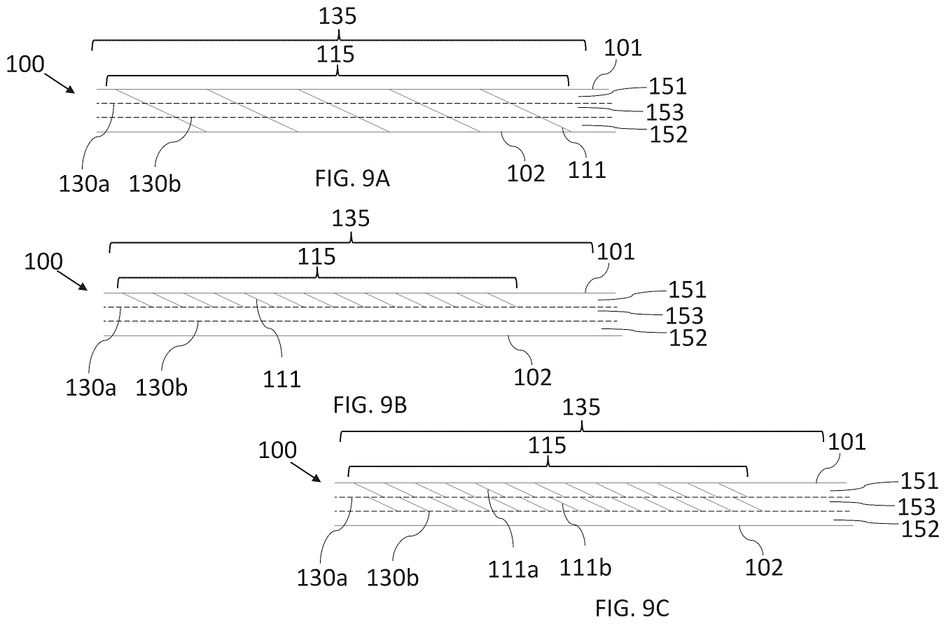

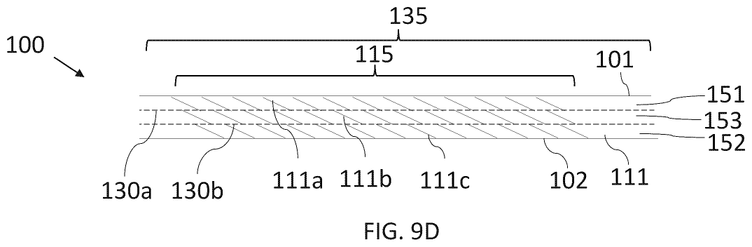

Although the embodiments described thus far have pertained to a single homogenizer embedded within an LOE, other embodiments are contemplated herein in which two or more such homogenizers are embedded within the LOE. FIGS. 9A-9D illustrate one set of embodiments in which a pair of homogenizers 130a and 130b are deployed so as to subdivide the thickness of the LOE 100 between the major external surfaces 101, 102 into three layers of equal thickness, designated 151, 152, and 153. In the embodiment illustrated in FIG. 9A, each facet in the set of facets 111 contiguously extends across the three layers 151, 152, 153. Here, the facets 111 can be tightly spaced to compose an almost uniform plane.

The embodiment illustrated in FIG. 9B is similar to the configuration shown in FIG. 8B, whereby the facets 111 are located in only one of the layers 151.

In the embodiment illustrated in FIG. 9C, two layers 151, 153 of the three layers contain facets. Here, similar to as in FIGS. 8A and 8C, the homogenizer 130a separates between the facets 111 so as to subdivide the facets 111 into a first set of facets 111a in the upper layer 151 and a second set of facets 111b in the middle layer 153. Although FIG. 9C shows that the two sets of facets 111a and 111b are laterally offset (displaced), one with respect to the other, embodiments are contemplated herein in which no offset is present and each facet in the set of facets 111 contiguously extends across the two layers 151, 153.

FIG. 9D shows a further embodiment, in which the homogenizers 130a and 130b separate between the facets 111 so as to subdivide the facets 111 into a first set of facets 111a in the upper layer 151, a second set of facets 111b in the middle layer 153, and a third set of facets 111c in the lower layer 152. Here, the three sets of facets are laterally offset one with respect to the other.

In the embodiments illustrated in FIGS. 9B-9D, the periodicity of the facets is dense, as compared to the periodicity of the facets in FIG. 9A, which provides a further mechanism for homogenization of the output image illumination.

In the embodiments of FIGS. 9A-9D , the reflectivity of one of the homogenizers 130a can be about 50%, and the reflectivity of the other homogenizer 130b can be about 33%.

As should be apparent, the embodiments illustrated in FIGS. 5A-9D can easily be extended to the case of n homogenizers that subdivide the thickness of the LOE into n+1 layers of equal thickness for integer values of n greater than 2. In certain embodiments, the reflectivity of the k^{th} homogenizer can be 1/(k+1). As should also be apparent, the image illumination can be injected into the LOE according to the various configurations discussed above in order to meet requirements for aperture filling. For example, in one configuration, the image illumination can be injected such that initially the ascending rays span the entire cross-section of the LOE (i.e., the LOE is initially filled with illumination corresponding to the collimated image or corresponding to a conjugate of the collimated image). As another example, the image illumination can be injected such that both the ascending rays and the descending rays 11a initially enter one of the layers 151 but do not initially enter the other two layers 152, 153.

It has also been found that an LOE having a beam multiplying region 135, containing one or more planar parallel beam splitters 130, that overlaps either partially or fully with a coupling-out region 115 (i.e., partially or fully overlaps with facets 111), such as the LOE illustrated in FIGS. 5A-9D , can be particularly effective with facets 111 having a selected steep or shallow deployment angle relative to the major external surfaces 101, 102, preferably a deployment angle being selected from a range between 55° and 70°, and more preferably a deployment angle in a range between 55° and 65°. The choice of whether to use such deployment angles for facets can be a function whether the facets couple-out the ascending rays or the descending rays, which is a function of the angles at which the image illumination is coupled into the LOE region 110. For example, such deployment angles are particularly suitable for coupling out the descending rays, whereas other angled facets are more suitable for coupling out the ascending rays.

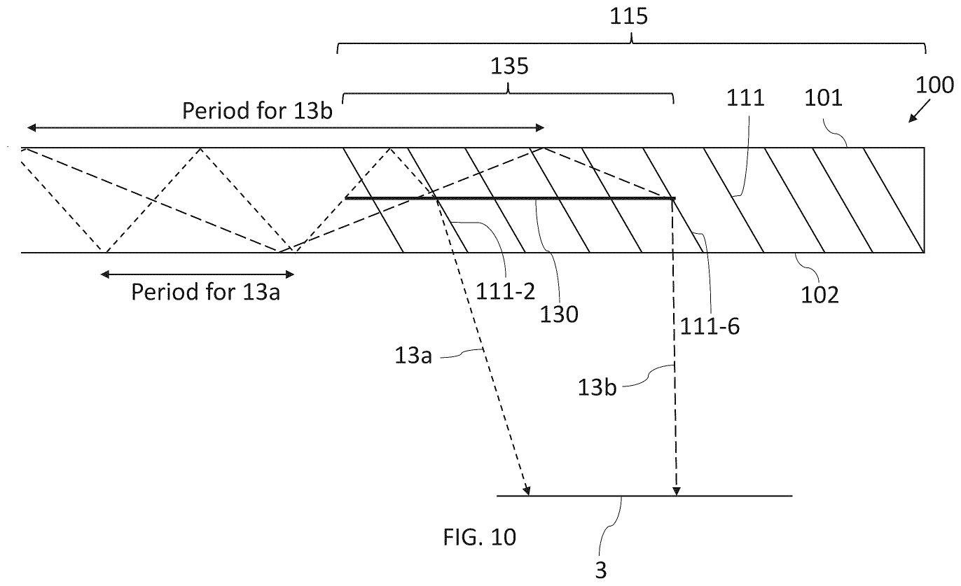

The advantage of employing facets at such particular deployment angles, in combination with a beam multiplying region in overlapping relation with the facets, is illustrated schematically in FIG. 10, in the context of a non-limiting example deployment angle and beam multiplying region deployment. In the illustrated example, the facets 111 have a deployment angle of approximately 60°, which is measured relative to the major external surfaces 101, 102 (i.e., 30° measured relative to the normal to the major external surfaces 101, 102). Furthermore, the beam multiplying region 135 only partially overlaps with the coupling-out region 115 (having ten facets 111), such that the beam splitter 130 fully overlaps with the first five facets 111 and partially overlaps with the sixth facet, and does not overlap with the last four facets 111. Two representative rays 13a and 13a of the output illumination (i.e., the coupled-out image), reaching the EMB 3 where the observer's eye is located, are also shown in FIG. 10. Coupled-out ray 13a is at the edge of the FOV and reaches the EMB 3 after being deflected out of the LOE from a further-away facet (in this case the second facet 111-2) that is closer to the left-edge of the LOE (i.e., closer to the coupling-in region of the LOE). Coupled-out ray 13b, which is at or near the center of the FOV, reaches the EMB 3 after being deflected out of the LOE from a more central facet (in this case the sixth facet 111-6, out of ten total facets). Furthermore, the period of the propagating field corresponding to ray 13a (represented in the figure as dashed lines) is much shorter than the period of the propagating field corresponding to ray 13b (represented in the figure as long dashed lines), where the period for a field is defined as the length along the LOE that the field travels between consecutive interaction with the same major external surface. This means that for the propagating image illumination of the field corresponding to ray 13a, the apertures will be filled immediately after encountering the first one or two facets 111. For the propagating image illumination of the field corresponding to ray 13b, the entire length of the beam splitter 130 is needed for aperture filling, but this is acceptable because the ray 13b only reaches the EMB 3 after being deflected from facets 111-6 that are located further along the LOE along the direction of the propagating image illumination.

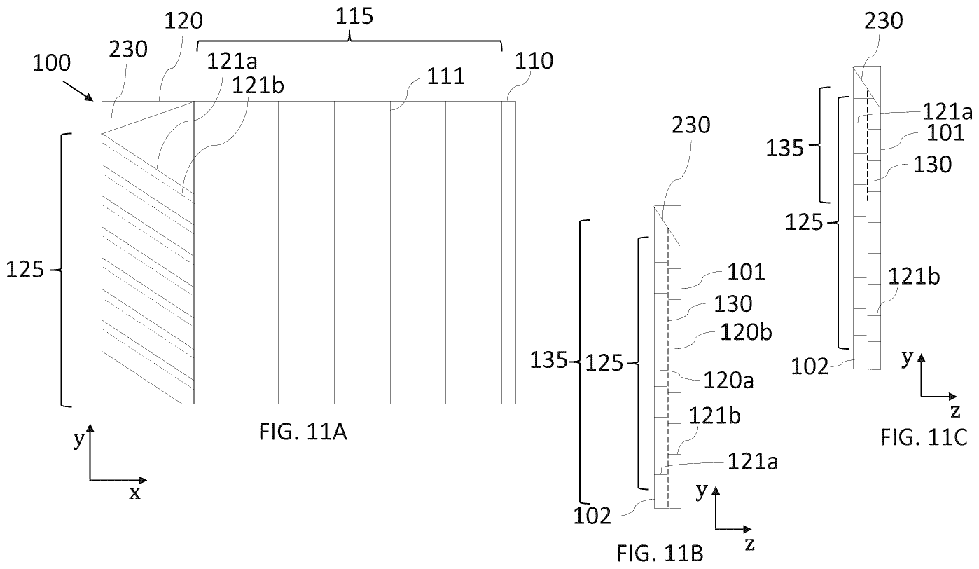

The embodiments described thus far have pertained to a planar homogenizing element (or elements) deployed internally to a 1D LOE in the coupling-out region of the LOE. However, embodiments of the present disclosure also pertain to deployment of such homogenizing element(s) internally to 2D LOEs, such as the LOE illustrated in FIGS. 3A-3C . For example, in one set of embodiments, the planar homogenizing element(s) can be deployed in the coupling-out region 115 of the first LOE 110. In a further set of embodiments, the planar homogenizing element(s) can be deployed in the second LOE 120 instead of the first LOE 110. FIGS. 11A and 11B illustrate an LOE according to one such set of embodiments of the present disclosure in which one or more planar homogenizing elements is deployed internal to the LOE in the coupling region 125 of the second LOE 120. Here, a beam multiplying region 135 is located in the second region 120 and contains a planar beam splitter 130 deployed internal to the LOE 100 and parallel to the major external surfaces 101, 102 at a mid-plane of the LOE 100 so as to subdivide the thickness of the LOE 100 between the major external surfaces 101, 102 into two layers of equal thickness, designated 120a and 120b. The planar homogenizing element 130 subdivides the facets 121 of the coupling region 125 into a first set of facets 121a located in one of the layers 120a, and a second set of facets 121b, parallel to the facets 121a, located in the other layer 120b. Thus, the LOE 100 in FIGS. 11A and 11B contains facets in both layers 120a and 120b, on either side of the planar homogenizing element 130. In order to maintain high optical resolution, parallelism between the two sets of facets 121a and 121b should be maintained with high accuracy, typically on the order of 30 arcseconds. In the illustrated embodiment, the two sets of facets 121a and 121b are laterally offset (displaced), one with respect to the other, by a preferably predesigned or deliberate lateral offset amount along the direction of propagation of the image illumination through the LOE region 120 (the vertical (Y) direction in the figure). The lateral offset amount is typically in the range between 10 microns and 100 microns.

As can be seen in FIG. 11B, the beam multiplying region 135 extends across the entire coupling region 125 so as to overlap with all of the facets 121a and 121b. However, the beam splitter 130 may be truncated so as to extend only partially into the coupling region 125, for example similar to as described with reference to FIGS. 7A and 7B. FIG. 11C shows an example of such an embodiment, wherein the beam splitter 130 only partially overlaps with the facets 121a and 121b.

As should be apparent, although FIGS. 11B and 11C illustrate embodiments in which the two sets of facets 121a and 121b are laterally displaced, one with respect to the other, along a displacement direction (e.g., the Y direction), embodiments are contemplated herein in which there is no lateral displacement between the sets of facets. The conditions/requirements for such non-displaced embodiments are similar to those discussed above in the context of 1D LOEs. Furthermore, for similar reasons as described above in the context of the 1D LOEs, in certain embodiments the facets of the coupling region 125 may be deployed at an oblique deployment angle (relative to the direction of propagation of the image light) selected from a range between 55° and 70°, and more preferably a deployment angle in a range between 55° and 65°.

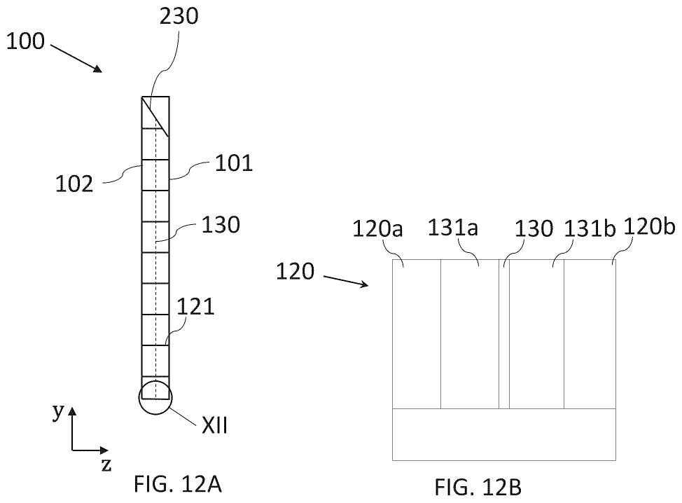

In certain situations, it may be preferable that the planar beam splitter 130 operate in one polarization state, and the facets in the region of the LOE in which the beam multiplying region 135 is located operate in another polarization state. This is often the case when the propagating light impinges the facets at or close to Brewster's angle, where it can become difficult to design optical coatings that effect the desired reflectivity for one polarization state (for example P-polarized light). In such cases, it may be desired to rotate the polarization state of the light before entering the beam splitter 130 and immediately after exiting the beam splitter 130. FIGS. 12A and 12B illustrate an embodiment of an LOE which effectuates such polarization rotation. Here, a pair of optical retarders 131a and 131b (e.g., half waveplates) are deployed internal to the LOE, in the respective layers 120a and 120b, and parallel to the major external surfaces 101, 102, with the beam splitter 130 sandwiched between the two optical retarders 131a and 131b. The optical retarders 131a and 131b and the beam splitter 130 can be configured as a stacked structure of the beam splitter coating. The optical retarders 131a and 131b rotate the polarization state of the impinging light from a first polarization state to a second polarization state that is orthogonal to the first polarization state. Consider, as an example, a configuration in which the beam splitter 130 operates on P-polarized light and the facets operate on S-polarized light. In such a configuration, the propagating image illumination may be S-polarized, and the polarization state of the propagating illumination is rotated by the first optical retarder 131a to become P-polarized. A proportion of the P-polarized light is transmitted by the beam splitter 130 and reaches the second optical retarder 131b, which rotates the light back to S-polarized, where it is then reflected from one of the major external surfaces of the LOE and continues propagating through the LOE. Another proportion of the P-polarized light is reflected by the beam splitter 130 and passes back through the first optical retarder 131a, which rotates the light back to S-polarized. The S-polarized light encounters one of the facets, which is designed (by its optical coating) to reflect S-polarized light, and thus a proportion of the S-polarized light is deflected by the facet. Another proportion of the S-polarized light is transmitted by the facet and is reflected from the other major external surface of the LOE and continues propagating through the LOE.

It should be apparent that similar techniques for polarization management can be employed for 1D LOEs. Thus, for example, the beam splitter of the embodiments illustrated in FIGS. 5A-8C may be similarly deployed between a pair of optical retarders.

Although only a single planar beam splitter 130 is shown in the embodiments illustrated in FIGS. 11A-11C , the beam multiplying region 135 may contain two or more such beam splitters so as to subdivide the thickness of the LOE into three or more layers of equal thickness. In other words, the beam multiplying region 135 may contain n homogenizers that subdivide the thickness of the LOE into n+1 layers of equal thickness for integer values of n greater than 2. In certain embodiments, the reflectivity of the kth homogenizer can be 1/(k+1).

As mentioned above, the inclusion of a beam multiplier region in overlapping relation with the coupling-out region 115 (in the case of 1D or 2D LOEs) or the coupling region 125 (in the case of 2D LOEs) provides a more compact LOE design, resulting in a smaller form factor of the overall device. In order to produce such compact LOEs, various fabrication methods have been developed by the inventors. In fact, the inventors have found that fabricating such LOEs is inherently difficult and complex, and it is therefore believed that the methods for fabricating the LOEs disclosed herein have independent utility from the LOEs themselves. The following paragraphs describe several methods for fabricating LOEs according to embodiments of the present disclosure. First, methods for fabricating 2D LOEs with one or beam splitters embedded in the coupling region 125 of the LOE region 120 will be described, and then methods for fabricating 1D LOEs with one or beam splitters embedded in the coupling-out region 115 will be described. The methods for fabricating 1D LOEs can then also be applied to methods for fabricating 2D LOEs with one or more beam splitters embedded in the coupling-out region 115. The fabrication methods of the present disclosure include numerous steps, including various bonding steps, where one optical element is bonded to another optical element. Throughout this document, the term “bonding” should be understood to mean attaching with an optical glue or adhesive.

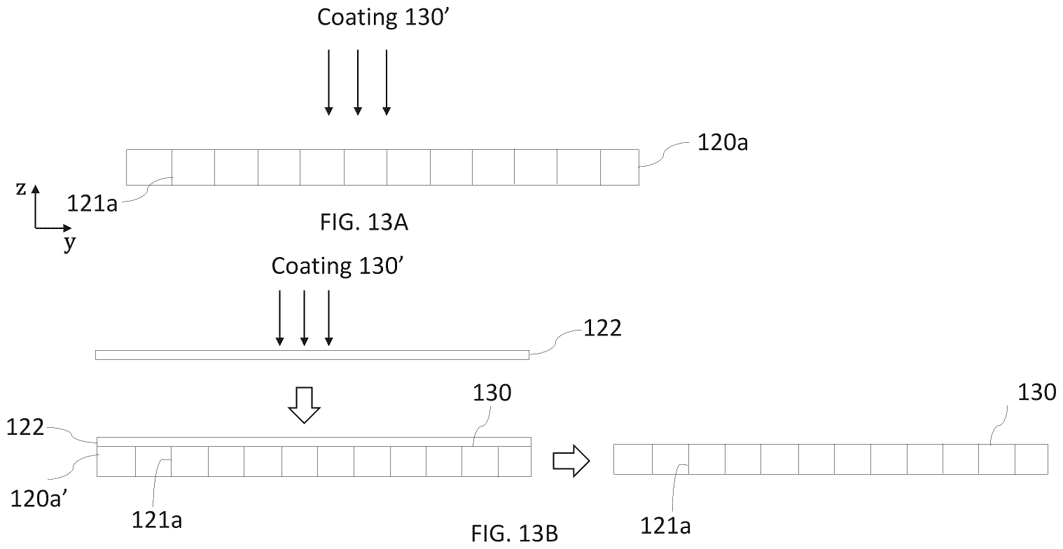

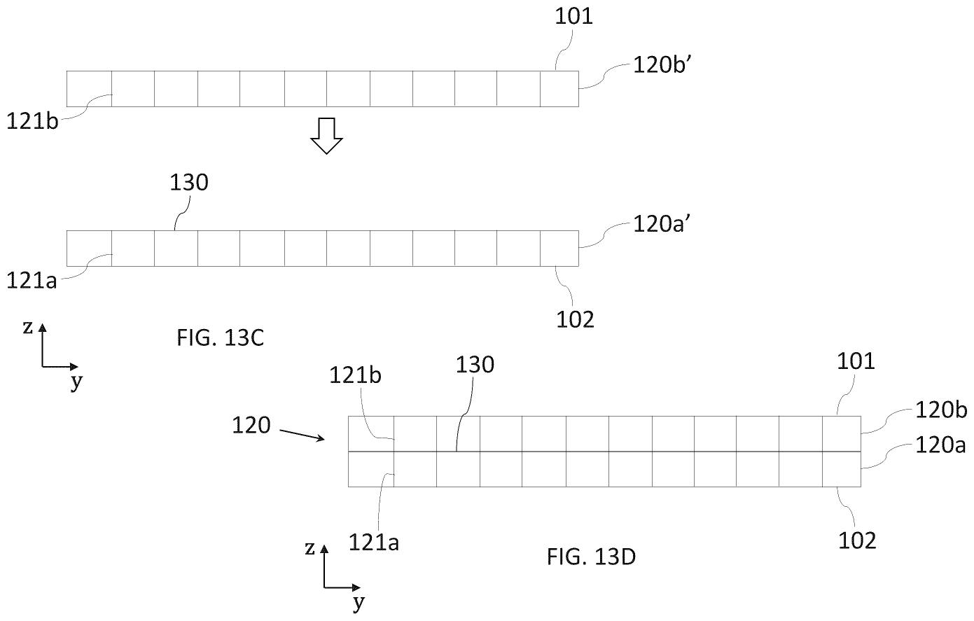

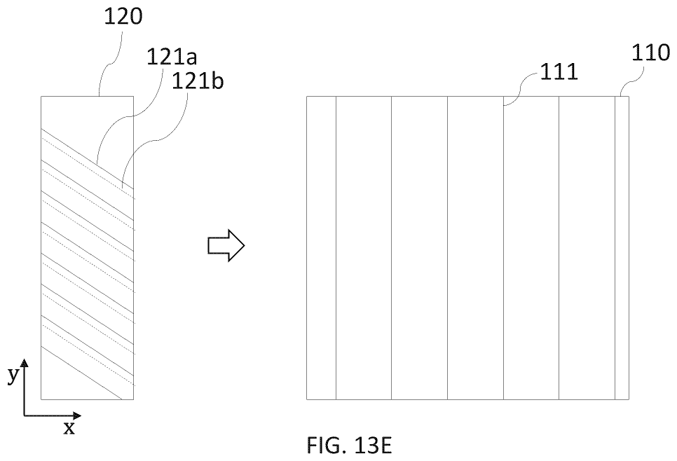

Referring now to FIGS. 13A-13E , and with particular reference to FIG. 13A, an optical structure 120a′, having embedded therein a set of planar, mutually-parallel, partially-reflecting surfaces (facets) 121a, is obtained. The structure 120a′ will ultimately become the layer 120a of LOE region 120. A homogenizer coating 130′, namely a partially reflective coating, is applied directly onto the optical structure 120a′. The application of the coating 130′ on the structure 120a′ forms the beam splitter 130. Since the coating 130′ is applied onto an element that includes embedded elements (facets 121a), that may be sensitive, the application of the coating may require a special coating process, for example, one that is applied at relatively low temperatures. Alternatively, as shown in FIG. 13B, the coating 130′ can be applied onto a blank plate 122 to form the beam splitter on the plate 122. The plate 122 (with the coating 130′) is then bonded to the structure 120a′, such that the coating 130′ is applied onto the structure 120a′ to form the beam splitter 130 on the element 120a. The blank plate 122 can then be lapped and polished, such that a minimal layer of the plate 122 is left, typically on the order of 10 microns. The processes in FIGS. 13A and 13B lead to equivalent results.

Next, as illustrated in FIG. 13C, a second optical structure 120b, having embedded therein a second set of planar, mutually-parallel, partially-reflecting surfaces (facets) 121b, is obtained. The structure 120b′ will ultimately become the other layer 120b of LOE region 120. The structure 120b′ is bonded onto the structure 120a′ having the beam splitter 130 (produced via the processes in FIG. 13A or FIG. 13B) to produce region 120 (FIG. 13D), having an embedded beam splitter 130 which subdivides the region 120 into the two layers 120a and 120b and which subdivides the facets in the region 120 into two sets of facets 121a and 121b. In certain embodiments, the two structures 120a′ and 120b′ can be bonded together such that the two sets of facets 121a and 121b are laterally displaced, one with respect to the other, by an offset amount, preferably in the range between 10 microns and 100 microns. The resultant region 120 can then be bonded to the region 110 with embedded facets 111 (which can be manufactured separately) to form a complete LOE 100, as shown in FIG. 13E.

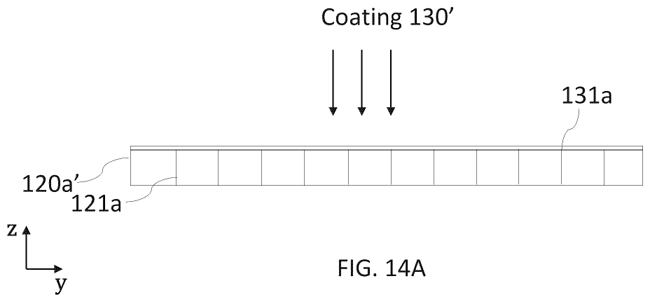

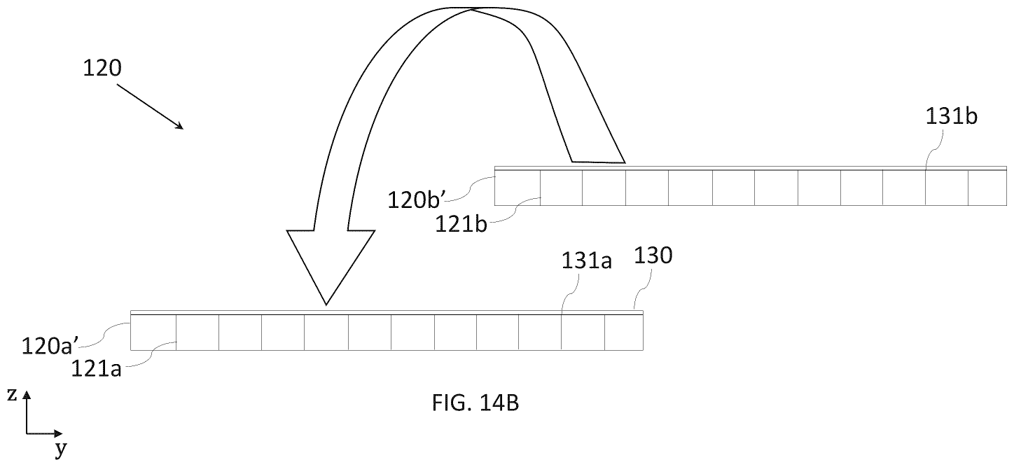

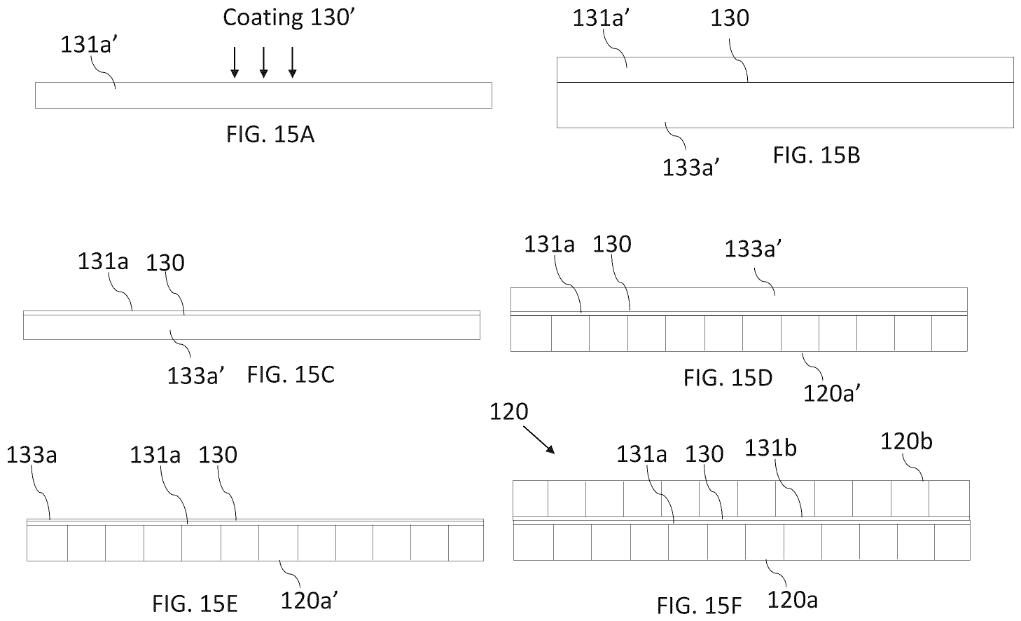

FIGS. 14A-14B and FIGS. 15A-15F illustrate embodiments for producing an LOE with a homogenizing element 130 sandwiched between a pair of optical retarders embedded in the coupling region 125, for example the LOE illustrated in FIGS. 12A and 12B.

In FIG. 14A, a first optical retarder 131a (e.g., a half waveplate) is bonded onto a first optical structure 120a′ having facets 121a, and is then coated with a partially reflective homogenizing coating 130′. Then, as shown in FIG. 14B, a second optical structure 120b′ having another set of facets 121b is bonded to a second optical retarder 131b (e.g., half waveplate), and the joint structure of structure 120b′ with retarder 131b is bonded to the joint structure formed in FIG. 13A to form the region 120 illustrated in FIGS. 12A and 12B.

Alternatively, FIGS. 15A-15F illustrate a production process which does not require applying a coating onto sensitive embedded elements. As shown in FIG. 15A, the homogenizing coating 130′ is applied to a blank plate 131a′ of birefringent material to form the beam splitter 130 on the plate 131a′. The plate 131a′ with the beam splitter 130 is then bonded to a blank plate 133a′, as shown in FIG. 15B. The birefringent plate 131a′ can then be thinned down to form the required optical retarder 131a (typically thickness in the range between of 1 microns and 100 microns), as shown in FIG. 15C. The structure of FIG. 15C is then bonded onto the structure 120a′ having facets 121a, as shown in FIG. 15D. The plate 133a′ can then be thinned to minimal thickness, typically in the range between of 10 microns and 100 microns, forming element 133a, as shown in FIG. 15E. Finally, the process is repeated so as to form an optical structure 120b′ with a bonded optical retarder 131b (with or without the beam splitter), and the two structures 120a′ and 120b′ are bonded together to produce the region 120, as shown in FIG. 15F.

In both methods of FIGS. 14A-14B and FIGS. 15A-15F , it is advantageous to apply the homogenizer coating 130′ on both of the structures 120a′ and 120b′, in order to minimize mechanical stress caused by the homogenizer, which may distort the final optical region 120. It is also noted that in both methods of FIGS. 14A-14B and FIGS. 15A-15F, the two optical structures 120a′ and 120b′ can be bonded together such that the two sets of facets 121a and 121b are laterally displaced, one with respect to the other, by an offset amount, preferably in the range between 10 microns and 100 microns. If bonding the optical structures 120a′ and 120b′ together for lateral displacement of the facets, any excess or overhanging portions of the optical structures 120a′ and/or 120b′ may be trimmed off and polished.

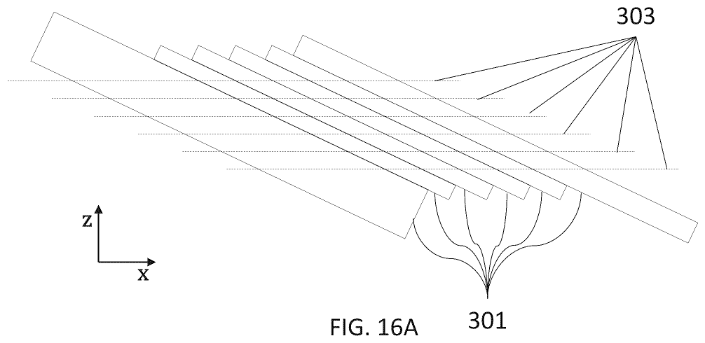

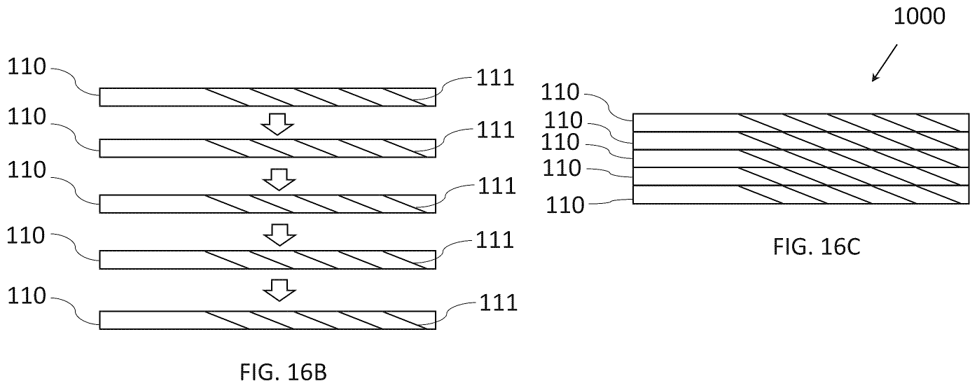

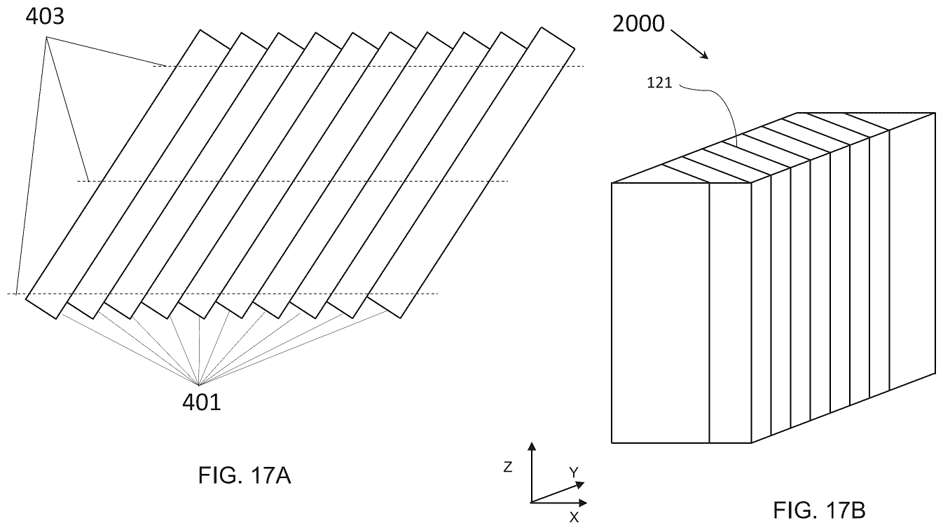

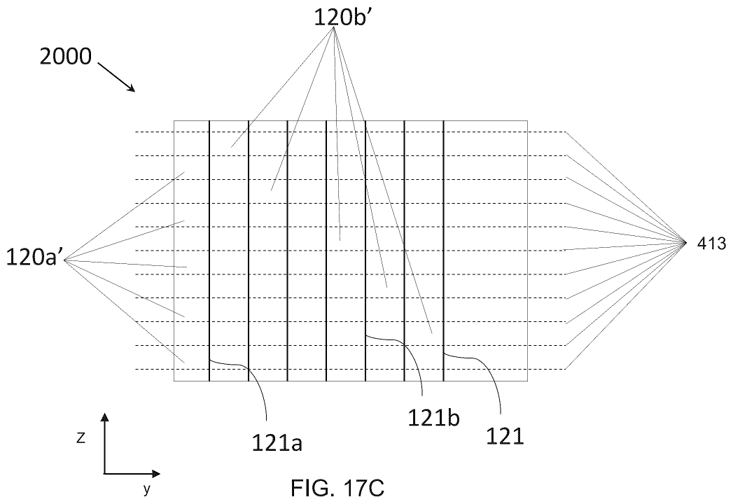

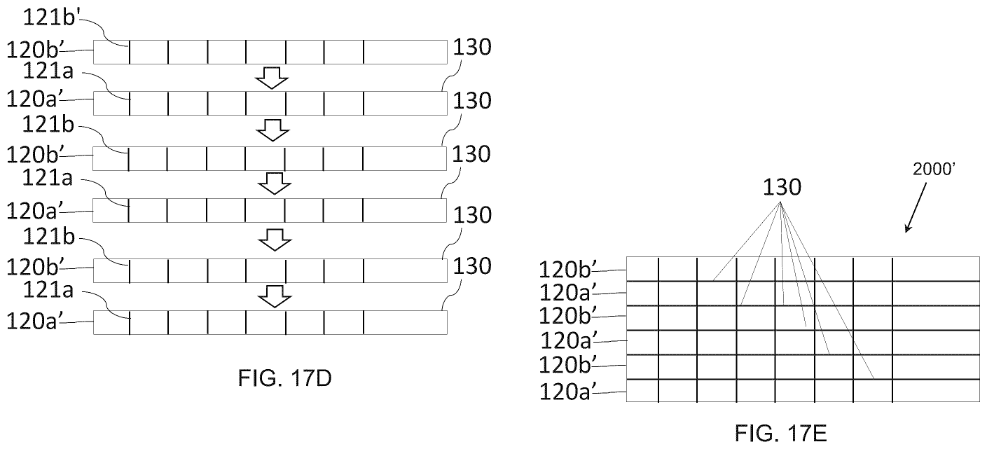

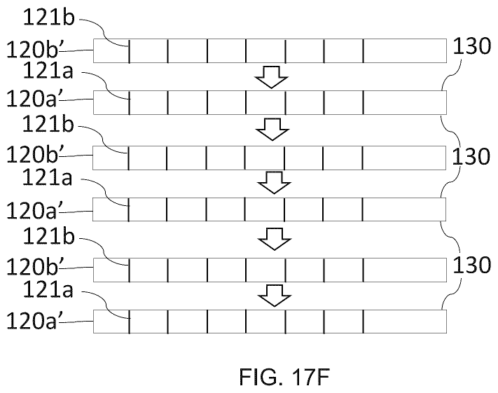

In order to fabricate large quantities of LOEs at reduced cost, it is advantageous to employ alternative manufacturing methods, where some of the processes are applied to a large number of elements simultaneously. FIGS. 16A-18C illustrate embodiments of such manufacturing methods. FIGS. 16A-16C show steps associated with fabricating an optical structure that contains multiple sub-structures, each of which will become region 110 in a final 2D LOE product, and FIGS. 17A-17F show steps associated with fabricating an optical structure that contains multiple sub-structures, each of which will become region 120 in a final 2D LOE product.

As shown in FIG. 16A, individual coated plates 301 are bonded together, and then cut/sliced along parallel cutting planes 303 to form a plurality of the regions 110 (which are precursor 1D LOEs). Each of the precursor LOEs 110 has a pair of parallel major external surfaces and plurality of partially reflective mirrors (facets) 111 internal to the LOE and obliquely inclined relative to the major external surfaces. The facets 111 are formed from the coating applied to the plates. The slicing along the cutting planes 303 is made such that the required angular orientation (oblique inclination angle) of the facets 111 is achieved. As shown in FIGS. 16B and 16C, the plurality of precursor 1D LOEs 110 are arranged in a stack and bonded together to form a bonded stack (optical structure) 1000.

As shown in FIGS. 17A and 17B, individual coated plates 401 are bonded together, and are sliced along cutting planes 403 (FIG. 17A) so as to form one or more optical structures 2000 (one of which is shown in FIG. 17B) with embedded facets 121 (formed from the coatings applied to the plates). The structure 2000 is then sliced along cutting planes 413 to extract structures 120a′ and 120b′ (FIG. 17C). The optical structures 120a′ and 120b′ are then directly coated or bonded to a coated plate with homogenizing coating 130′, for example as described previously with reference to FIGS. 13A-13D . The optical structures 120a′ and 120b′ could also be bonded to optical retarders, for example as described previously in with reference to FIGS. 14A-15F . The individual optical structures 120a′ and 120b′, with the applied beam splitters 130 (and optionally optical retarders), are then arranged in a stack (FIG. 17D) and bonded together to form a new optical structure 2000′ (FIG. 17E). An alternative construction of optical structure 2000′ is shown in FIG. 17F. Here, the optical structure 2000′ can be formed from a plurality of neighboring pairs of structures 120a′ and 120b′, where one of the structures 120b′ of each pair does not have a homogenizer applied to it, and the other structure 120a′ of each pair has a homogenizer applied to it. Such a structure helps minimize mechanical stress.

It is noted that in the processes illustrated in FIGS. 17D and 17F, the optical structures 120a′ can be staggered relative to the optical structures 120b′ and then bonded together, such that for adjacent (neighboring) optical structures 120a′ and 120b′, the two sets of facets 121a and 121b are laterally displaced, one with respect to the other, by an offset amount, preferably in the range between 10 microns and 100 microns. Excess or overhanging portions of the optical structure 2000′ may be trimmed off and polished.

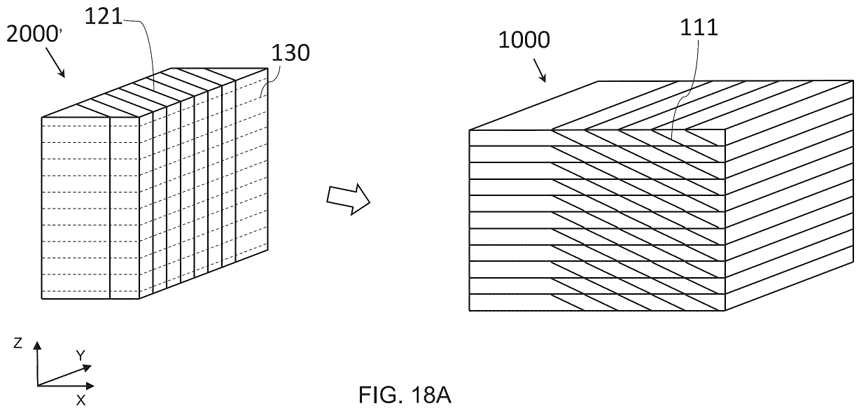

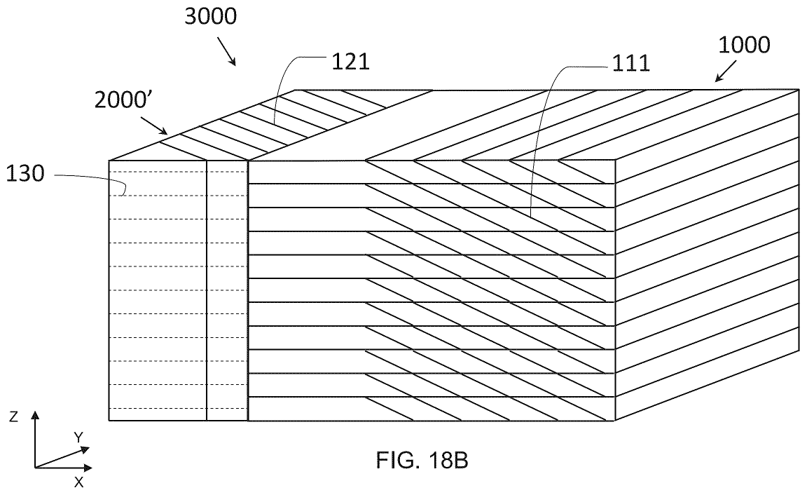

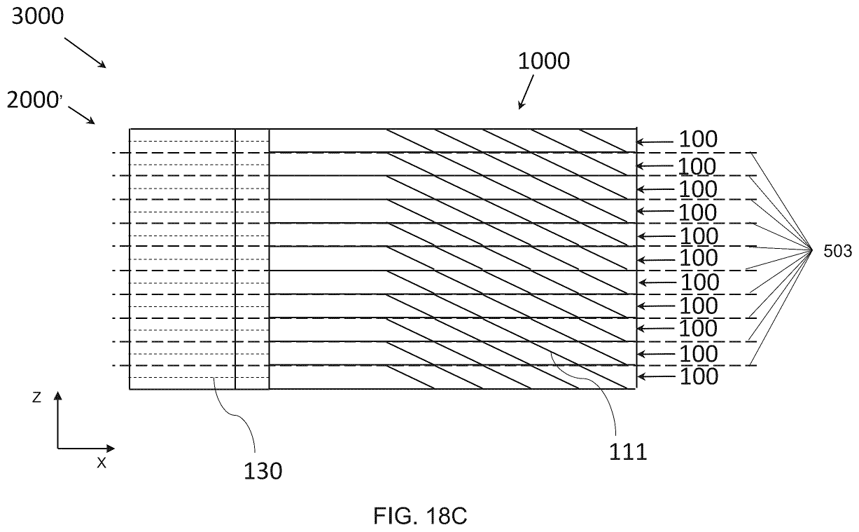

As shown in FIG. 18A, the optical structures 1000 and 2000′ are aligned. The alignment is such that the requisite orientation between the sets of facets 121 and 111 is achieved. Then, as shown in FIG. 18B, the aligned optical structures 1000 and 2000′ are bonded together to form a composite optical structure 3000.

As shown in FIG. 18C, the optical structure 3000 is then sliced along parallel cutting planes 503 so as to extract individual 2D LOEs 100, where each extracted 2D LOE has two LOE regions 110 and 120 containing its own set of facets 111 and 121, with one of the LOE regions 120 having an embedded homogenizer 130, which may or may not be sandwiched between a pair of optical retarders. The cutting planes 503 are parallel to the major external surfaces of the precursor LOEs that form the stack 1000, and the spacing between the cutting planes 503 is preferably such that the homogenizer 130 of each extracted LOE 100 is at a mid-plane of the extracted 2D LOE. Each extracted LOE may then optically be polished at its major external surfaces.

In the fabrication methods described above, the coating 130′ can be applied to the optical structures (e.g., structures 120a′, 120b′, plate 131a′, etc.) so that the coating 130′ extends across the entire surface area of the optical structure, such that when the optical region 120 is formed (e.g., by bonding together the structures 120a′ and 120b′), the beam splitter formed by the coating 130′ overlaps all of the facets of the optical region 120 (i.e., such that the beam splitter extends across the entirety of the coupling region containing the facets). In certain embodiments, however, the coating 130′ can be applied so as to extend across only part of the surface area of the optical structure, such that when the optical region 120 is formed, the beam splitter formed by the coating 130′ overlaps with only some (specifically the first or first few) of the facets of the optical region 120. It should also be noted that the methods described above can easily be extended to produce LOEs where more than one beam splitter is embedded in the coupling region 125 of the optical region 120.

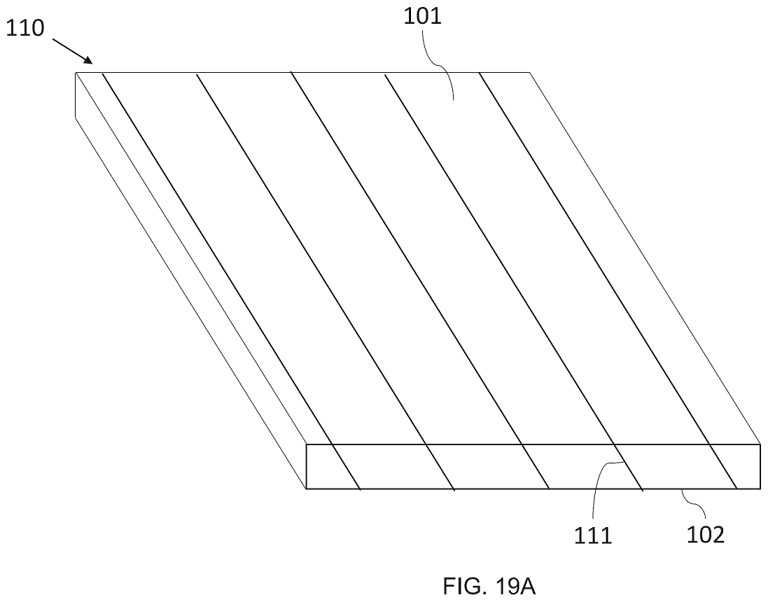

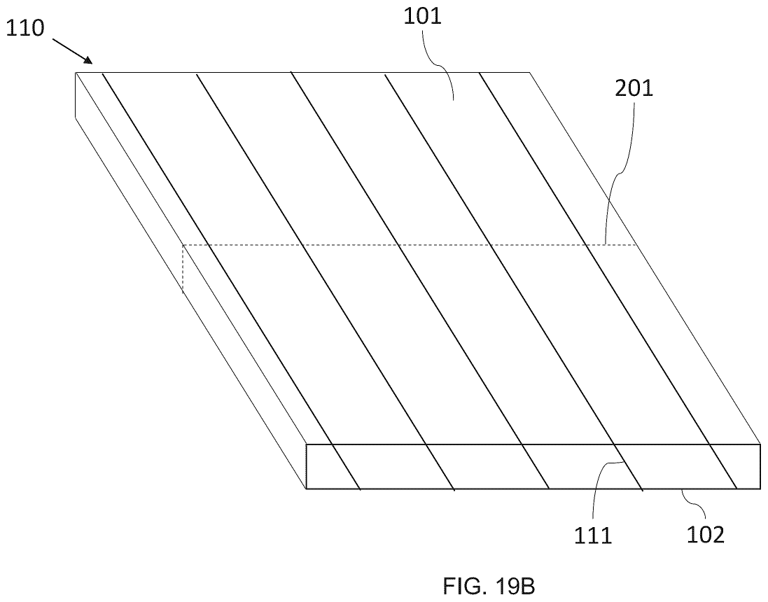

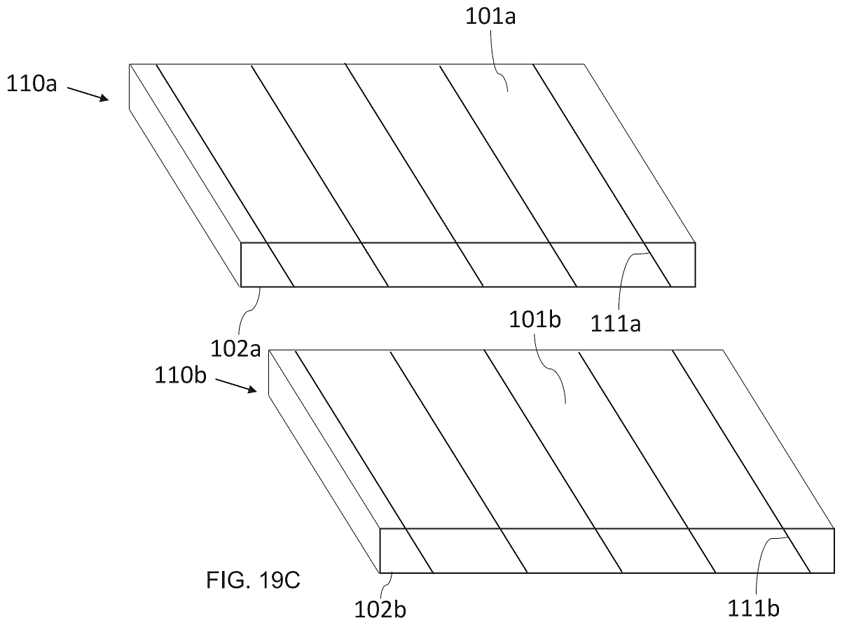

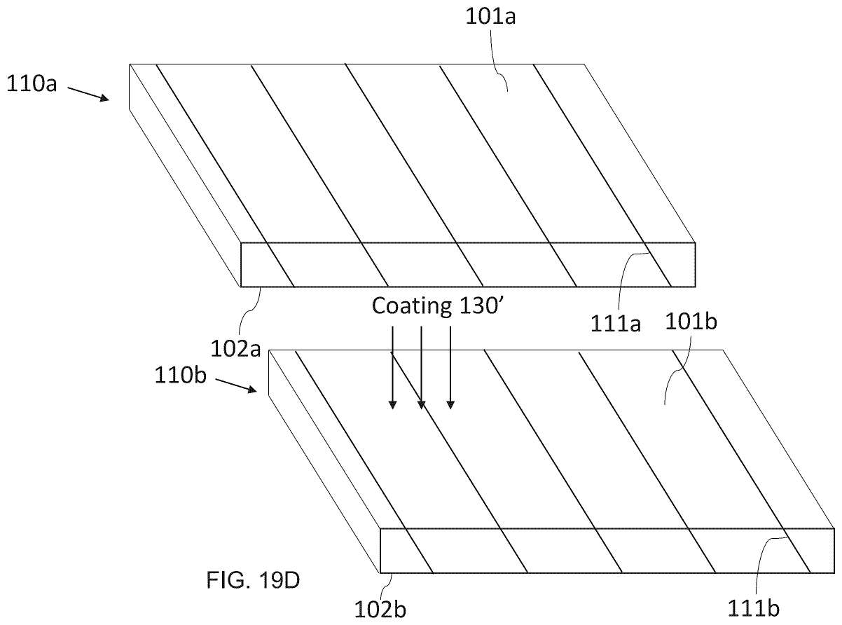

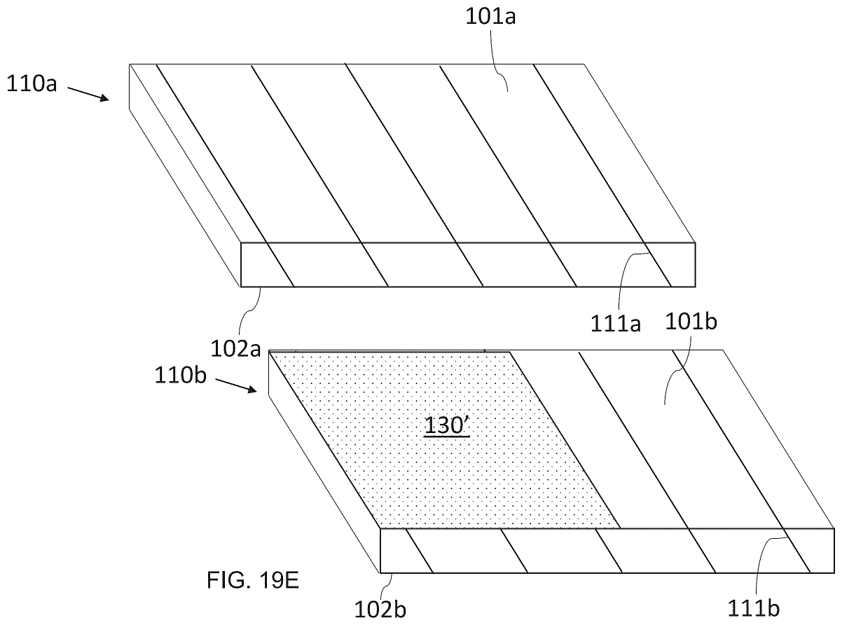

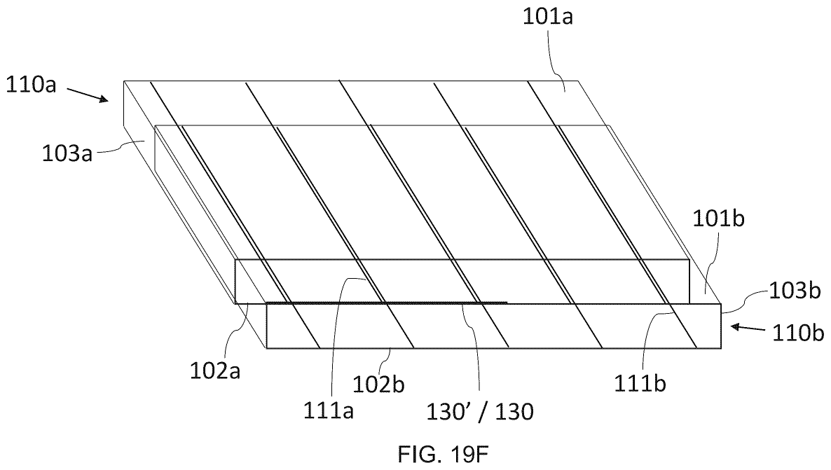

Referring now to FIGS. 19A-19D, methods for fabricating 1D LOEs with one or beam splitter embedded in the coupling-out region 115 will be described. It is initially noted that these methods are applicable for producing standalone 1D LOEs, such as those described with reference to FIGS. 5A-8C, and can also be used in processes for producing the region 110 of 2D LOEs in which the coupling region 125 is free from beam splitters.

First, as illustrated in FIG. 19A, a precursor LOE 110 is obtained, for example using the techniques described above with reference to FIG. 16A. The periodicity (distance between the facets 111) of the LOE 110 is double that of the final 1D LOE. The LOE 110 is then cut along a cutting plane 201 (represented in FIG. 19B as dashed lines), that is perpendicular to the major external surfaces 101, 102 of the LOE 110 so as to bisect the LOE 110, thereby producing two identical LOEs 110a and 110b, as shown in FIG. 19C. As a particular result of the bisection, the angle of the facets 111a relative to the surfaces 101a, 102a is identical to the angle of the facets 111b relative to the surfaces 101b, 102b.

Then, as illustrated in FIG. 19D, a homogenizer coating 130′, namely a partially reflective coating, is applied to one of the major external surfaces of one of the LOEs 110a, 110b. In the illustrated example, the coating 130′ is applied to the major external surface 101b of the LOE 110b. The coating 130′ may be applied to the entire surface 101b so as to completely overlap with all of the facets 111b, or can be applied to a portion of the surface 101b so as to overlap with only some of the facets 111b (including the first facet). FIG. 19E shows the coating 130′ (represented as dotted pattern) after application to a portion of the surface 101b so as to overlap with only some of the facets 111b (in this example the first three facets). In certain embodiments, the coating 130′ can be applied to one of the major external surfaces 101 of the precursor LOE 110 prior to bisecting the LOE 110. For example, the coating 130′ can be applied to all or part of half of the surface 101 prior to bisecting.

The two LOEs 110a and 110b are then bonded together at the major external surfaces 102a and 101b, such that the coating 130′/beam splitter 130 is sandwiched between the surfaces 102a and 101b, as shown in FIG. 19F. In the figure, the coating 130′/beam splitter 130 fully overlaps with the first three facets of each set of facets 111a and 111b.

It is noted that prior to bonding together the two LOEs 110a and 110b, care should be taken to maintain parallelism between the facets 111a and 111b. This can be easily achieved by rotating the two surfaces 102a and 101b together until they are mutually parallel. Also, it is noted that in the illustrated embodiment the two LOEs 110a and 110b are bonded together such that there is a lateral between the two sets of facets 111a and 111b, preferably in the range between 10 microns and 50 microns. Excess and/or overhanging portions 103a and 103b of the LOEs 110a and 110b may be trimmed off and polished to form the final 1D LOE product. In certain embodiments, the two LOEs 110a and 110b may be bonded together such that there is no lateral offset between the facets 111a and 111b.

It is additionally noted that because the final 1D LOE product has a thickness that is twice the thickness of the LOEs 110a, 110b, the precursor LOE (from which LOEs 110a, 110b are extracted) can be fabricated to have a thickness that is half of the desired thickness of the final LOE product. Thus, if the final LOE product is to have a desired thickness of h, the precursor LOE can have a thickness of h/2. This can be achieved, for example, by providing appropriate spacing between the parallel cutting planes used to produce the precursor LOE. Furthermore, since the cut along the plane 201 bisects the precursor LOE, the width of the precursor LOE (measured in the direction perpendicular to the plane 201) should be twice the desired width of the final LOE product.

The method described with reference to FIGS. 19A-19E is just one example embodiment of a method for producing a 1D LOE with an embedded beam splitter, and other embodiments are contemplated herein. For example, in one further embodiment, a precursor 1D LOE can be obtained and cut along a cutting plane located at a mid-plane between the external surfaces 101, 102 and parallel to the external surfaces 101, 102 to produce two identical LOEs of half the final LOE thickness. The beam splitter coating can then be applied to one of the two LOEs, and the two LOEs can then be bonded together, similar to as described above. In such an embodiment, the width and thickness of the precursor LOE can be the same as the desired width and thickness of the final LOE product. However, there is a strict requirement for parallelism of the cutting plane since the cut along the cutting plane will form a major external surface of each of the two LOEs, and that major external surface must be parallel to its opposite major external in order to support internal reflection. In another embodiment, the final LOE can be produced from two separate precursor LOEs, each having width the same as the final LOE product and thickness that is half of the final LOE product. The beam splitter coating can then be applied to one of the two precursor LOEs, and the two LOEs can then be bonded together, similar to as described above.

The 1D LOEs produced according to the methods described above, for example with reference to FIGS. 19A-19F , can also be used in processes of fabricating large quantities of 2D LOEs in which the beam splitter is deployed in the LOE region 110. For example, a plurality of 1D LOEs, each having an embedded beam splitter, can be arranged in a stack and bonded together to produce a bonded stack (similar to the optical structure 1000 of FIG. 18A, but with embedded beam splitters in the 1D LOEs). Then, the optical structure 2000 of FIG. 17B can be bonded with the stack of 1D LOEs having embedded beam splitters, in a similar fashion to as illustrated in FIGS. 18A and 18B, to form a composite optical structure. The composite optical structure can then be cut along parallel cutting planes (in a similar fashion to as illustrated in FIG. 18C) to extract 2D LOEs, where each extracted 2D LOE has two LOE regions 110 and 120 containing its own set of facets 111 and 121, with one of the LOE regions 110 having an embedded homogenizer 130 and the other region 120 being free from homogenizers.

The LOEs 100 having at least one embedded beam splitter according to the embodiments of the present disclosure as described herein can be deployed as part of a device, such as the near-eye display of FIGS. 1A and 1B. For example, a 1D LOE having at least one beam splitter embedded in region 110 can be deployed as part of the near-eye display of FIG. 1A, and a 2D LOE having at least one beam splitter embedded in region 110 or region 120 can be deployed as part of the near-eye display of FIG. 1B.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the disclosure.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. An optical system for directing image illumination corresponding to a collimated image to an eye-motion box for viewing by an eye of a viewer, the optical system comprising a light-guide optical element (LOE) formed from transparent material, the LOE comprising:
a pair of major external surfaces that are parallel so as to support propagation of the image illumination within the LOE by internal reflection at the major external surfaces;
a coupling-out configuration associated with a coupling-out region of the LOE and configured for coupling out at least part of the image illumination from the LOE towards the eye-motion box, the coupling-out configuration including a plurality of mutually-parallel partially reflecting surfaces deployed within the LOE and obliquely inclined relative to the major external surfaces; and
at least one planar beam splitter internal to the LOE and parallel to the major external surfaces, the at least one planar beam splitter at least partially extending into the coupling-out region so as to overlap with some but not all of the mutually-parallel partially reflecting surfaces.

2. The optical system of claim 1, wherein the plurality of mutually-parallel partially reflecting surfaces have a selected deployment angle relative to the major external surfaces, the selected deployment angle being selected from a range between 55 and 70 degrees.

3. The optical system of claim 1, wherein the at least one planar beam splitter consists of a single beam splitter that subdivides the plurality of mutually-parallel partially reflecting surfaces into a first set of partially reflecting surfaces and a second set of partially reflecting surfaces, and wherein the first set of partially reflecting surfaces is laterally offset from the second set of partially reflecting surfaces.

4. The optical system of claim 1, further comprising: an image projecting arrangement for generating the image illumination corresponding to the collimated image, the image projecting arrangement being optically coupled to the LOE so as to introduce the image illumination into a coupling-in region of the LOE so as to propagate within the LOE by internal reflection.

5. The optical system of claim 1, wherein the LOE includes a first LOE region and a second LOE region and the major external surfaces extend across the first and second LOE regions, wherein the coupling-out region is located in the first region of the LOE, and wherein the second LOE region includes a coupling region having a coupling configuration associated therewith, the coupling configuration including a second plurality of mutually-parallel partially reflecting surfaces non-parallel to the plurality of mutually-parallel partially reflecting surfaces of the coupling-out configuration, the second plurality of mutually-parallel partially reflecting surfaces configured for deflecting at least part of the image illumination, propagating within the second LOE region by internal reflection at the major external surfaces, from the second LOE region into the first LOE region so as to propagate within the first LOE region by internal reflection from the major external surfaces.

6. The optical system of claim 5, further comprising: an image projecting arrangement for generating the image illumination corresponding to the collimated image, the image projecting arrangement being optically coupled to the LOE so as to introduce the image illumination into a coupling-in region of the LOE so as to propagate from the coupling-in region toward the second LOE region by internal reflection.

7. The optical system of claim 1, wherein the LOE further comprises a first optical retarder and a second optical retarder, each of the first and second optical retarders being internal to the LOE and parallel to the major external surfaces, wherein the planar beamsplitter is sandwiched between the first and second optical retarders.

8. The optical system of claim 1, wherein the at least one planar beam splitter includes two or more planar beam splitters that subdivide a thickness of the LOE between the major external surfaces into three or more layers of equal thickness.

9. The optical system of claim 1, wherein the at least one planar beam splitter consists of a single beam splitter that subdivides a thickness of the LOE between the major external surfaces into two layers of equal thickness, and wherein the image illumination that enters one of the two layers corresponds to both the collimated image and a conjugate of the collimated image.

10.-17. (canceled)
